(19) United States
(12) Patent Application Publication
(10) Pub. No.: US 2022/0051188 A1
(43) Pub. Date: Feb. 17, 2022

(54) SYSTEM AND METHOD FOR MANAGEMENT OF SUBSTANCES

(71) Applicant: BARVENTORY CORP., Hamilton (CA)

(72) Inventors: Jeffery Dean Stoodley, Burlington (CA); Michael Wayne Peters, Hamilton (CA)

(21) Appl. No.: 17/511,889

(22) Filed: Oct. 27, 2021

Related U.S. Application Data
(63) Continuation-in-part of application No. PCT/IB2020/050855, filed on Feb. 4, 2020.
(60) Provisional application No. 62/842,999, filed on May 3, 2019.
(60) Provisional application No. 63/162,366, filed on Mar. 17, 2021.
(60) Provisional application No. 63/106,867, filed on Oct. 28, 2020.

(51) Int. Cl. G06Q 10/08; G06F 16/22

(52) U.S. Cl. CPC G06Q 10/0875; G06F 16/22

(57) ABSTRACT

A system and method for real-time inventory monitoring and acquisition of substances are described. The system includes a monitoring device for monitoring the substance's weight or volume and an interconnected database and processing subsystem for calculating a volume, spillage, revenue, cost of consumption, and remaining stock. The method includes storing calculation data related to a substance on a database, scanning or weighing a container holding the substance, and determining the volume, revenue, cost of consumption, loss of stock, and remaining stock.

### PRIORITY CLAIM

This application is a non-provisional of 63/162,366, filed on Mar. 17, 2021, presently pending. This application is also a non-provisional of U.S. provisional application Ser. No. 63/106,867, filed on Oct. 28, 2020, presently pending. This application is also a continuation in part of PCT application PCT/IB2020/050855 filed on Feb. 4, 2020, which in turn claimed priority to U.S. provisional application 62/842,999, filed on May 3, 2019, presently expired. The contents of each application are hereby incorporated by reference.

### TECHNICAL FIELD

The present disclosure generally relates to the management of substance inventory. More particularly, the present disclosure relates to a system and method for monitoring substances' consumption and maintaining inventory.

### BACKGROUND

Monitoring the use and consumption of substances is an integral element of many industries. This is particularly true in the food and beverage industry, where inventory monitoring is critical to financial success. Inventory is an essential element in the food and beverage industry, as a relatively large inventory of specific substances is carried that are susceptible to changes in demand based on the day of the week, season, holidays, and specific occasions. The average consumption of substances in a bar or a restaurant can fluctuate dramatically. There is a need to not only monitor the use and consumption of substances but to acquire data of such use and reliably anticipate future consumption and modify the inventory so as to avoid running out of substances during peak times.

It is often hard to assess the level of inventory of substances, for example, liquids, at various time points. Consumption of liquids varies throughout specific time points, and as such, liquids are consumed at various rates. Furthermore, visual assessment of the substances is often inaccurate as the substances are housed in various sized and shaped containers, which can distort the users' understanding of the consumption rate and amount remaining. Often, the containers which house the liquid substance are comprised of non-transparent material, thereby limiting the user from determining the amount of substance remaining. Understanding of the consumption of substances is an essential element in many industries as it provides the users an ability to not only determine the rate of consumption but effectively determine the size of inventory and order requirements prior to running out of a specific substance.

The monitoring of the use and consumption of substances is particularly relevant in the food and beverage industry. Bar and restaurant owners have a need to monitor the amount of liquor, beer, wine, and food consumed in a night. The monitoring is not only necessary to determine the amount of substances sold and the subsequent revenue generated, it is also necessary to ensure stock. Stock needs to be acquired prior to the inventory running out. Orders for additional stock can often take days, and depending on the substance, weeks to deliver, making the monitoring of the consumption of substances vital to the operation of a bar or restaurant.

The food and beverage industry is heavily dependent on the revenue generated from the sale of liquor, beer, and wine. These consumable substances are sold at a price per unit volume. Over the day, the amount of consumption of liquor, beer, and wine heavily dictates the revenue generated throughout the day. As employees in the bar industry are at the point of sale, they are responsible for obtaining payment for the consumable substances. Each employee, at the end of their shift, is required to cash out. The cash-out procedure involves inventorying the amount of liquor, beer, and wine consumed, or dispensed, and providing the cash value of the consumption to the bar. Often, this involves the employee having to utilize a number of methods in order to obtain an accurate amount of consumed substances. The employee is required to not only calculate the amount of substances consumed but determine the cost of the consumed substance based on the bar assigned value. This is often time-consuming and can be altered with ease, which will affect the revenue generated by the bar.

Running out of stock is inefficient and leads to a loss of revenue and potential loss of repeat clientele. Clientele can be very particular with the substance they are consuming. If the bar or the restaurant is unable to provide the client with the specific liquor, beer, wine or food of choice due to running out of stock, then the client will most likely stop ordering additional drinks and will be less likely to return at some point in the future. Stock inventory is routinely assessed, wherein the employee or a manager accounts for all of the substances and determines whether additional substances need to be purchased. The purchasing is often dependent on the employee's understanding of the consumption, time of year, and the time needed for delivery of the consumable substances. Bars and restaurants are particularly vulnerable to changes in the demands of consumable products, based on seasonal fluctuations, holidays, and population statistics. These trends can often be predicted and prepared for if the consumption rates are followed through data acquisition and analysis. It is also inefficient to overstock all consumable substances due to the cost and space restrictions within the bar or restaurant.

Various attempts have been made to provide an efficient use and means and devices for inventorying substances. Methods and devices such as U.S. Pat. No. 6,450,406 (Brown); US Patent Application No. 2005/0000737 (Fox); and U.S. Pat. No. 5,837,944 (Herot) provide such examples of managing and inventorying consumable substances.

Brown discloses a portable, integrated scanner apparatus that scans and weighs bottles of liquor within a bar inventory. The data obtained by the apparatus is stored, and a software program calculates the inventory, stock amounts, and profits. Brown discloses a manner in which the apparatus monitors the consumption of substances through a weigh scale. A scale weighs the bottled substances, and a scanner reads a UPC code to associate said weight to a particular substance. The information is stored on the scale and is assessed on a remote computer. Brown fails to disclose a manner of continuously monitoring the inventory, thereby allowing the user to know not only how many ounces of the substance remain within the container, but how many containers were consumed. Furthermore, Brown fails to assess the resultant data and formulate trends that allows the bar to accurately predict consumption of substances in the future, and based on the trend, automatically order stock if current stock is deemed insufficient to fill the current need.

Fox discloses a commodity management apparatus designed to weigh kegs in the bar for an accurate inventory control system for determining the amount of draught being dispensed and the amount remaining. Fox provides for a convenient, controlled, and accurate method and documentation of the draught beer being dispensed. Fox allows the owners of the bar or restaurant a more thorough and productive decision-making process in placing accurate orders. The mechanism of reordering is placed on the owner/manager to assume the amount that will be consumed. To determine the amount of substance remaining within the keg, the user is required to physically attend at the location of the keg and read the input window as to the amount of beer left in ounces. Fox fails to provide a continuous monitoring system that can effectively assess the pour rate and the amount of beer pour per glass. Furthermore, Fox fails to provide accurate information to the bartender at the point of sale, which is essential in determining when the keg is close to being empty and when a barback needs to replace the existing keg. Finally, Fox fails to collect the data, which is necessary to determine consumption trends, an element essential for predicting future consumption.

Herot discloses a beverage measuring system for simultaneously measuring and displaying the temperature and the amount of beverage remaining within a keg. The device includes an electronic scale, a thermometer and a digital display which displays the number of servings of the beverage remaining within the keg and the temperature. Herot, by measuring the weight of the keg assesses the amount of substance remaining, which is converted into the number of pours remaining through an algorithm. The algorithm can be modified based on the size of the glass used in dispensing the beer within the keg. Herot fails to provide accurate flow rate information to the bartender, only the amount of beer glasses that remain. This can be problematic when there is a pour-over, or foaming. The resultant information on the number of beer glasses remaining will be inaccurate. Herot also fails to provide an effective system of assessing the amount of draught beer consumed, which is necessary to determine the revenue generated. Furthermore, and similarly to Fox, Herot fails to collect the data on beer consumption, which is necessary to determine consumption trends, an element essential for predicting future consumption.

One of skill in the art would know that for a given establishment such as a bar or a restaurant, there may be tens if not hundreds of possible food and beverage substances that need to be monitored. Furthermore, there is a need to constantly correlate data from other subsystems within such an establishment for processing and determination as necessary. For example, there may be a need to correlate weight data with billing data to determine if fraud is taking place. There may also be a need to correlate weight data with inventory data to determine if new orders need to be made. As one of skill in the art would appreciate, the data sets needed to perform such operations may be large in size, possibly in the gigabyte (GB) range. Also, so as to ensure efficient operation of the establishment, the data to perform this processing would need to be as up-to-date as possible and these operations would need to be automated to ensure an accurate reflection of the current business state of the establishment. Therefore, there is a need to collect and process large amounts of data to ensure efficient operation of the establishment and make determinations as necessary.

There is a need for a system and method of accurately and continuously live monitoring the consumption of the consumable product, for assessing the revenue generated through the consumption of each consumable product, and to control the inventory based on various factors to ensure that stock does not run out.

### SUMMARY

A further understanding of the functional and advantageous aspects of the invention can be realized by reference to the following detailed description and drawings.

An object of the present disclosure is to provide an inventory monitoring device for collecting data for inventory analysis and acquisition of stock. A further object of the present disclosure is to provide a method for monitoring and maintaining a stock of substances.

Thus by one broad aspect of the present invention, a system is provided for real-time monitoring of a consumption of a plurality of substances comprising a monitoring device, wherein the monitoring device measures a weight of one of the plurality of substances; and a database and a processing subsystem coupled to each other via one or more interconnections, wherein the database stores one or more calculation data related to the plurality of substances, wherein the one or more calculation data comprises at least one of: one or more density or specific gravity data; one or more revenue data; one or more cost data; and one or more inventory data; the monitoring device transmits a measurement data related to the weight of the substance via the one or more interconnections to the processing subsystem; and the processing subsystem: receives the transmitted measurement data via the one or more interconnections; retrieves at least one portion of the one or more calculation data from the database via the one or more interconnections; and determines, based on at least one portion of the measurement data and the at least one portion of the one or more calculation data, at least one of: a volume of the one of the plurality of substances; a generated revenue related to the one of the plurality of substances; a cost of consumption related to the one of the plurality of substances; and a remaining stock of the one of the plurality of substances.

By another broad aspect of the present invention, a system is provided for real-time monitoring of a consumption of a plurality of substances comprising: a monitoring device, wherein the monitoring device measures a fill level of one of the plurality of substances; and a database and a processing subsystem coupled to each other via one or more interconnections, wherein the database stores one or more calculation data related to the plurality of substances, wherein: the one or more calculation data comprises at least one of: one or more density or specific gravity data; one or more revenue data; one or more cost data; and one or more inventory data; the monitoring device transmits a measurement data related to the fill level via the one or more interconnections to the processing subsystem; and the processing subsystem: receives the transmitted measurement data via the one or more interconnections; retrieves at least one portion of the one or more calculation data from the database via the one or more interconnections; and determines, based on a least one portion of the measurement data and the at least one portion of the one or more calculation data, at least one of: a volume of the one of the plurality of substances; a generated revenue related to the one of the plurality of substances; a cost of consumption related to the one of the plurality of substances; and a remaining stock of the one of the plurality of substances.

By another broad aspect of the present invention, a system is provided to enable real-time monitoring of a consumption of a plurality of beverages comprising: one or more monitoring devices, wherein: the one or more monitoring devices comprise at least one keg monitoring device or at least one tabletop monitoring device; and the one or more monitoring devices measure one or more weights corresponding to one or more containers holding one or more volumes of one or more of said plurality of beverages; a database and a processing subsystem coupled to each other via one or more interconnections, wherein: the database stores one or more calculation data related to the plurality of beverages, wherein the one or more calculation data comprises at least one of: one or more density data; one or more revenue data; one or more cost data; and one or more inventory data; a first of the one or more monitoring devices transmits a measurement data related to a first of the one or more weights to the processing subsystem via the one or more interconnections; and the processing subsystem: receives the transmitted measurement data; retrieves at least one portion of the one or more calculation data from the database via the one or more interconnections; and calculates, based on at least one portion of the measurement data and the at least one portion of the one or more calculation data, at least one of: a first of the one or more volumes of the one of said plurality of beverages; a generated revenue related to the one of the plurality of beverages; a cost of consumption related to the one of the plurality of beverages; and a remaining stock of the one of the plurality of beverages.

By a further broad aspect of the present invention, a method is provided for live monitoring a sale of a substance comprising: storing one or more calculation data related to a plurality of substances on a database; scanning one of the plurality of substances to identify the substance; transmitting a measurement data related to the weight of the substance to a processing subsystem; retrieving at least one portion of the one or more calculation data from the database by the processing subsystem; determining, based on at least one portion of the measurement data and the retrieved at least one portion of the one or more calculation data, at least one of a volume of the one of said plurality of substances; a generated revenue related to the one of the plurality of substances; a cost of consumption related to the one of the plurality of substances; and a remaining stock of the one of the plurality of substances.

### BRIEF DESCRIPTION OF THE DRAWINGS

Embodiments disclosed herein will be more fully understood from the following detailed description taken in connection with the accompanying drawings, in which:

FIG. 1 illustrates a schematic diagram of an embodiment of a monitoring system of the present disclosure.

FIG. 2 illustrates a schematic diagram of an embodiment of a user device of the present disclosure.

FIG. 3 illustrates a schematic diagram of an example embodiment of a consumption analysis subsystem.

FIG. 4 illustrates an exploded perspective view of a tabletop inventory monitoring device, according to one embodiment of the present invention.

FIG. 5 illustrates a perspective view of the tabletop inventory monitoring device shown in FIG. 4;

FIG. 6 illustrates an aerial view of the tabletop inventory monitoring device housing base, according to one embodiment of the present invention;

FIG. 7 illustrates a perspective view of the tabletop inventory monitoring device housing lid, according to one embodiment of the present invention;

FIG. 8 illustrates a perspective view of the tabletop inventory monitoring device lacking the scale plate and the scale housing lid, according to one embodiment of the present invention;

FIG. 9 illustrates an exploded perspective view of a keg inventory monitoring device, according to one embodiment of the present invention;

FIG. 10 illustrates a perspective view of a weigh scale feet, according to one embodiment of the present invention;

FIG. 11 illustrates a perspective view of a seal of a tabletop inventory monitoring device according to one embodiment of the present invention;

FIG. 12 illustrates a perspective view of a load sensor, according to one embodiment of the present invention;

FIG. 13 illustrates a transparent perspective view of a tabletop unit, according to one embodiment of the present invention;

FIG. 14 is a flowchart for an embodiment of a method of management of liquor wine substances; according to one embodiment of the present invention; and,

FIG. 15 is a flowchart for an embodiment of a method of management of draught beer substances; according to one embodiment of the present invention.

FIG. 16 illustrates a user interface to enter a substance inventory, according to one embodiment of the present invention;

FIG. 17 illustrates an embodiment of a user interface to enter an inventory count;

FIG. 18 illustrates a user interface for an inventory control list, according to one embodiment of the present invention;

FIG. 19 illustrates a further embodiment of a user interface of the present invention;

FIG. 20 illustrates a further embodiment of a user interface of the present invention;

FIG. 21 illustrates a further embodiment of a user interface of the present invention.

FIGS. 22A and 22B illustrate an exploded and perspective view of a tabletop inventory monitoring device, according to a further embodiment of the present invention.

FIGS. 23A and 23B illustrate a perspective view and schematic of the use of the tabletop inventory monitoring device shown in FIGS. 22A and 22B.

FIG. 24 illustrates use of the tabletop inventory monitoring device shown in FIGS. 22A and B.

FIG. 25 further illustrates use of the tabletop inventory monitoring device shown in FIGS. 22A and B.

FIG. 26 further illustrates a schematic of use of the tabletop inventory monitoring device shown in FIGS. 22A and B.

FIG. 27 further illustrates uses of the tabletop inventory monitoring device shown in FIGS. 22A and B.

FIG. 28 further illustrates uses of the tabletop inventory monitoring device shown in FIGS. 22A and B.

### DETAILED DESCRIPTION

The present disclosure provides a system and method for the management of substances intended to overcome at least some of the limitations of conventional management practice. The systems and methods described herein allow a user to monitor and manage the use and consumption of substances while providing the ability to accurately predict and order stock for future consumption. The system and method for management of substances herein is described for use in the restaurant and bar industry, wherein substances monitored are food, liquors, wines, spirits and beers. A worker skilled in the relevant art would appreciate that the system and method for management of substances can be applied to other industries wherein substances are consumed. Such examples of industries include, but are not limited to, the pharmaceutical industry, chemical industry, and fuel industry. Furthermore, the system and method of management of substances can be extended to any substance housed within a container that is measured by weight. In the bar and restaurant, this can include, but is not limited to, juices, bottled still and sparkling water, cooking sauces and oils, and cleaning products.

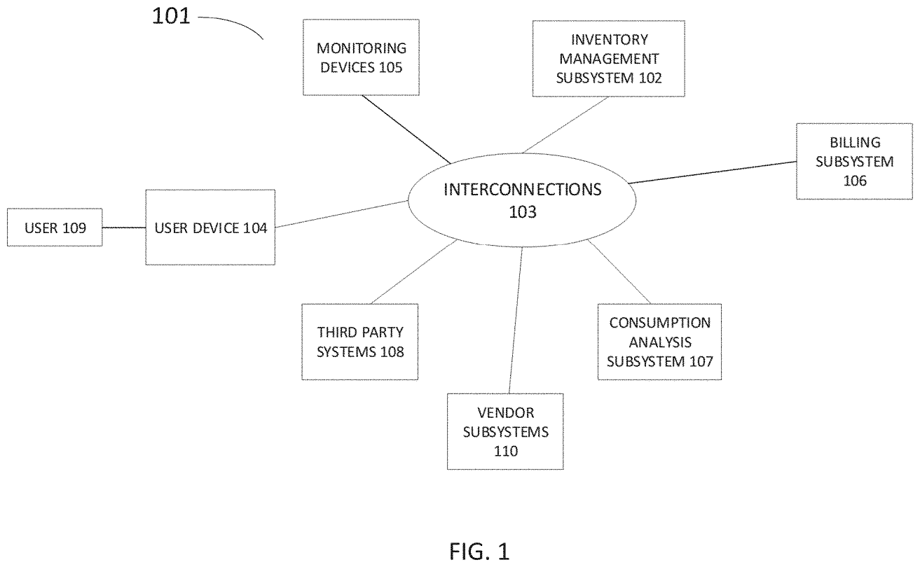

The system and method for management of substances described herein relate to the monitoring of the consumption and use of food, liquor, wine, and beer. Referring to FIG. 1, an example system 101 is illustrated. Interconnections 103 perform the function of communicatively coupling the various components of system 101 to each other. Interconnections 103 may be implemented in a variety of ways. For example, in some embodiments, interconnections 103 comprise one or more networks. In some of these embodiments, one or more of these one or more networks comprise one or more subnetworks. The one or more networks comprise, for example, wireless networks, wired networks, Ethernet networks, local area networks, metropolitan area networks, and optical networks. In some embodiments, the one or more networks comprise at least one of a private network such as a virtual private network, or a public network such as the Internet. In some embodiments, interconnections 103 also comprise one or more direct connections between the components of system 101. Various wired or wireless communications protocols known to those of skill in the art may be used to implement interconnections 103. These include, for example, near field communications (NFC), Wi-Fi, BLUETOOTH®, Radio Frequency Identification (RFID), 3G, Long Term Evolution (LTE), 5G and Universal Serial Bus (USB).

In an embodiment, communication between components of system 101 may be made through a barrier that would restrict a wireless signal but allow a low voltage radiofrequency to travel freely or communicate, for example, brick or steel walls. Low voltage radiofrequency signals are transmitted from a component of the system to a receiver in the system. The receiver receives the analog radiofrequency signal and converts the signal to a digital signal, which may then be sent by wireless connection to a remote server. A low power signal mechanism incorporates precise peripheral device clock control and clock gating, with device sleep and a low power watchdog timer wake-up scheme to maximize data transceiver sleep time. A low-power radiofrequency communication scheme between a multiple-master and multiple-slave configuration may be used. The master device is always on, and the slave device periodically wakes on a timer or event. The slave device sends a message to the master device, and the master sends a response to the slave device, thereby achieving two-way communication. The slave device then returns to sleep mode. Communication between master and slave devices should last no longer than 100 ms to maintain a low power profile.

Monitoring devices 105 measure either a weight of a container housing a substance, or a remaining volume of the substance within the container. Two examples of a monitoring device 105 are a tabletop inventory monitoring device and a keg monitoring device. These will be described in more detail later in the disclosure. In some embodiments, monitoring devices 105 are communicatively coupled to the rest of system 101 via interconnections 103. In other embodiments, monitoring devices 105 are coupled to the rest of system 101 via intermediary devices. An example of an intermediary device will be described below.

Monitoring devices 105 may further comprise components to recognize and track a user who dispenses a substance. One example for user recognition is a security token or fob, which could be a wristband with radiofrequency identification (RFID) tag, so when the user dispenses a substance the user can be identified, as well as the substance being dispensed. When a substance change event such as a weight change is triggered by the monitoring system, the monitoring system searches for a user in the RFID range. The system thereby acquires knowledge of a unique user to monitor system substance or substance container manipulations. Use of a security token can be used to confirm compliance, for example, that the person dispensing the substance is certified and has authority to dispense the substance.

In another example, monitoring devices 105 may use facial recognition to recognize and track a user who dispenses a substance. When a substance change event such as a weight change is triggered by the monitoring device, the monitoring device is triggered to capture an image of the monitoring deice vicinity. Image feature details are extracted via artificial recurrent neural networks to generate a user image and identify a user interacting with the monitoring device from a preset user identification database.

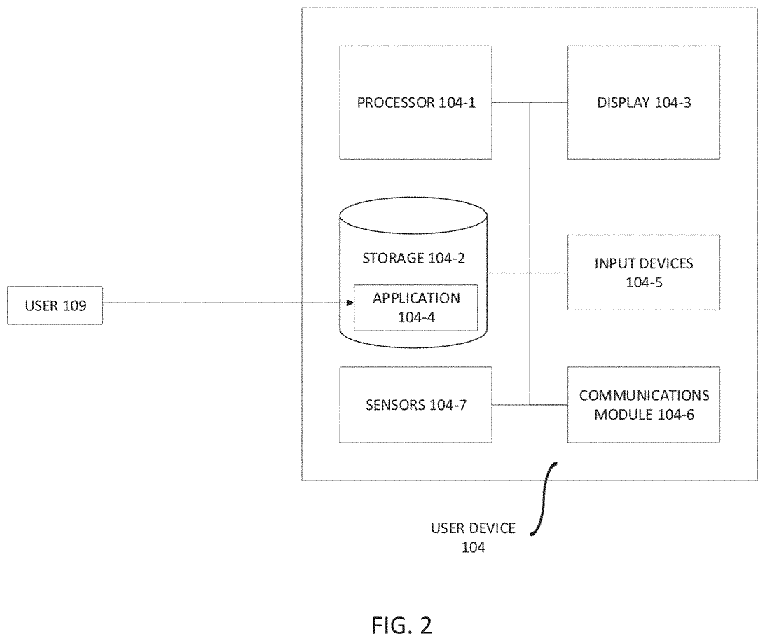

User device 104 is associated with user 109. User device 104 is, for example, a smartwatch, smartphone, tablet, laptop, or any appropriate computing and network-enabled device. An embodiment of user device 104 is shown in FIG. 2. Processor 104-1 performs processing functions and operations necessary for the operation of mobile device 104, using data and programs stored in storage 104-2. An example of such a program is an application or “app” 104-4, which will be discussed in more detail below. App 104-4 allows user 109 to interact with the rest of system 101. Display 104-3 performs the function of displaying data and information for user 109. Input devices 104-5 allow user 109 to enter information. This includes, for example, devices such as a touch screen, mouse, keypad, keyboard, microphone, camera, video camera, and so on. In one embodiment, display 104-3 is a touchscreen which means it is also part of input devices 104-5. Communications module 104-6 allows user device 104 to communicate with devices and networks external to user device 104. For example, user device 104 communicates with the other components of system 101 via interconnections 103 and communications module 104-6. Communications module 104-6 supports one or more wired or wireless communications via protocols and technologies such as a short-range wireless standard such as Bluetooth, or other wireless networks including Wi-Fi, Near Field Communications (NFC), Radio Frequency Identification (RFID), 3G, Long Term Evolution (LTE), 5G, wired or wireless Universal Serial Bus (USB) and other protocols and technologies known to those of skill in the art. Sensors 104-7 perform functions to sense or detect environmental or locational parameters. Sensors 104-7 include, for example, accelerometers, gyroscopes, magnetometers, barometers, Global Positioning System (GPS), proximity sensors, and ambient light sensors. The components of user device 104 are coupled to each other, as shown in FIG. 2.

Returning to FIG. 1, billing subsystem 106 operates to assist the bar or restaurant with the management of customer billing. Billing subsystem 106 performs functions such as generation of customer bills, collections of payments from customers, which includes, for example, receiving debit and credit card payments. In some embodiments, billing subsystem 106 is implemented using software. In other embodiments, billing subsystem 106 is implemented using a combination of hardware and software. Billing subsystem 106 is coupled to the other components of system 101 via interconnections 103.

Inventory management subsystem 102 operates to assist the bar or restaurant with the management of stock or inventory held by the bar or restaurant. Examples of functions performed by inventory management subsystem 102 include, for example,
recording current amounts of inventory
determining remaining stock of, for example, a food or beverage item
determining threshold levels of inventory needed for the bar or restaurant to function for a given period of time based on, for example, historical consumption patterns
determining a time to exhaustion of inventory based on, for example, determination of remaining stock and historical consumption data, and
determining whether there is a need to transmit requests for orders of food or beverage or other supplies based on the determination of the remaining stock.
   In some embodiments, these functions are performed in conjunction with one or more components of system 101. For example, in some embodiments, inventory management subsystem 102 works together with consumption analysis subsystem 107 to determine remaining stock, threshold levels or whether there is a need to transmit requests for orders of food or beverage. In some embodiments, these functions are performed using predictive analytics. In some embodiments, these functions are performed using artificial intelligence (AI) or machine learning (ML) techniques.

In some embodiments, the inventory management subsystem 102 is implemented using software. In other embodiments, the inventory management subsystem 102 is implemented using a combination of hardware and software. Inventory management subsystem 102 is communicatively coupled to the other components of system 101 via interconnections 103.

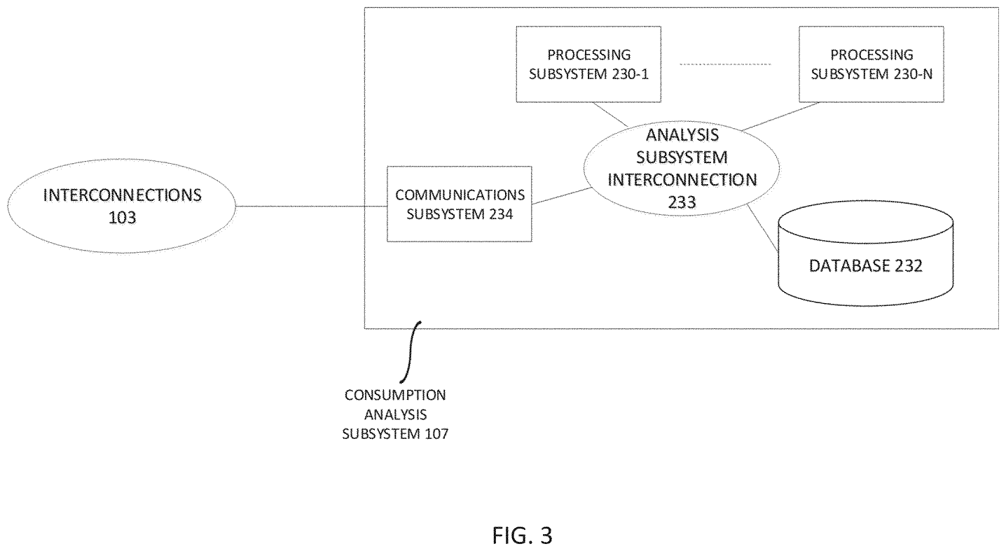

Consumption analysis subsystem 107 determines, calculates, and records past, current, and future consumption of substances within the bar or restaurant. An example detailed embodiment of consumption analysis subsystem 107 is shown in FIG. 3.

In FIG. 3, analysis subsystem interconnection 233 connects the various components of consumption analysis subsystem 107 to each other. In one embodiment, interconnection 233 is implemented using, for example, network technologies known to those in the art. These include, for example, wireless networks, wired networks, Ethernet networks, local area networks, metropolitan area networks, and optical networks. In one embodiment, interconnection 233 comprises one or more subnetworks. In another embodiment, interconnection 233 comprises other technologies to connect multiple components to each other, including, for example, buses, coaxial cables, USB connections, and so on.

Communications subsystem 234 receives information from and transmits information to the other components of system 101 via interconnections 103.

Database 232 stores information and data for use by consumption analysis subsystem 107. This information comprises, for example:
Measurement data received from monitoring devices 105;
Calibration data corresponding to each of the monitoring devices 105;
Device identifiers corresponding to each of the monitoring devices 105;
Container identifiers corresponding to containers of food or beverage items;
Consumption data calculated based on the received measurement data;
Nutritional data;
Type of substance;
One or more calculation data related to food and beverages sold within the bar or restaurant comprising at least one of:
   Density or specific gravity data for conversion of weights to volumes and volumes to weights;
   Revenue data, including, for example, prices per volume or weight of a substance;
   Cost data, including, for example, supplier cost per volume or weight of a sub stance;
   Inventory data;
   Temperature data related to the temperature of one or more parts of the bar or restaurant or kegs or fridges, and
   Distance data related to the distance of lines from a container to a tap.
Storage of authentication data such as usernames and passwords to enable users to log in via app 104-4.

As will be explained further below, users such as user 109 can input data to database 232 using, for example, app 104-4 running on user device 104. In other embodiments, data is uploaded to database 232 from other components of system 101, such as third-party systems 108 and vendor subsystems 110.

In one embodiment, database 232 further comprises a database server. The database server receives one or more commands from, for example, processing subsystem 230-1 to 230-N and communication subsystem 234, and translates these commands into appropriate database language commands to retrieve and store data into database 232. In one embodiment, database 232 is implemented using one or more database languages known to those of skill in the art, including, for example, Structured Query Language (SQL). In a further embodiment, database 232 stores data for a plurality of users. Then, there may be a need to keep the set of data related to each user separate from the data relating to the other users. For example, in some embodiments, a server or bartender is restricted to viewing measurement and consumption data related to only his or her shifts, while a manager may be able to view a larger data set comprising, for example, measurement and consumption data for all server and bartender shifts. To achieve this, in some embodiments, database 232 is partitioned so that data related to each user is separate from the other users. In some embodiments, each user has an account with a login and a password or other appropriate security measures to ensure that they are only able to access their data, and unauthorized access of their data is prohibited. In a further embodiment, when data is entered into database 232, associated metadata is added so as to make it more easily searchable. In a further embodiment, the associated metadata comprises one or more tags. In yet another embodiment, database 232 presents an interface to enable the entering of search queries. In some embodiments, the data stored within database 232 is encrypted for security reasons. In further embodiments, other privacy-enhancing data security techniques are employed to protect database 232.

Processing subsystems 230-1 to 230-N perform processing and analysis within consumption analysis subsystem 107 using one or more algorithms and programs residing on consumption analysis subsystem 107; data received from communications subsystem 234 and one or more portions of calculation data and/or other data retrieved from database 232. The algorithms and programs are stored in, for example,
database 232 as explained above, or
within processing subsystems 230-1 to 230-N

Examples of operations performed by processing subsystems 230-1 to 230-N include but are not limited to:
Calculation of consumption data based on measurement data received from communications subsystem 234;
Determination of at least one of
   a volume of a beverage
   revenue generated related to a beverage
   a cost associated with the consumption of a beverage and
   a remaining stock of a beverage
based on the received measurement data and retrieved calculation data stored in database 232;
Determination of the volume of foam based on the temperature and distance data stored in database 232;
Determination of a volume of spillage based on the determination of the volume of foam;
Determination of time to exhaustion of a food or beverage item based on a determination of remaining stock of the food or beverage item and historical consumption data;
Determination of occurrence of fraud events based on a comparison of billing data received from billing subsystem 106;
Determination of false pour events as will be further detailed below; and
Alerting of user 109 via transmission of alerts to app 104-4 running on user device 104.

In some embodiments, these operations are performed by processing subsystems 230-1 to 230-N in conjunction with one or more other components of system 101. For example, in some embodiments, processing subsystems 230-1 to 230-N work together with inventory management subsystem 102 to determine the remaining stock of a food or beverage item. In some embodiments, this determination of remaining stock is then used to determine a time to exhaustion of the food or beverage item based on historical consumption data retrieved from database 232. In other embodiments, processing subsystems 230-1 to 230-N receive billing data from billing subsystem 106 via interconnections 103 and a communications subsystem 234 and determine the occurrence of fraud events based on a comparison of the received billing data and the determined generated revenue.

Various implementations are possible for consumption analysis subsystem 107 and its components. In one embodiment, consumption analysis subsystem 107 is implemented using a cloud-based approach. In another embodiment, consumption analysis subsystem 107 is implemented across one or more facilities, where each of the components are located in different facilities and interconnection 233 is then a network-based connection. In a further embodiment, consumption analysis subsystem 107 is implemented within a single server or computer. In a further embodiment, consumption analysis subsystem 107 is implemented across multiple servers or computers. In yet another embodiment, consumption analysis subsystem 107 is implemented in software. In another embodiment, consumption analysis subsystem 107 is implemented using a combination of software and hardware.

Some restaurants have a plurality of locations, and therefore have a need for monitoring and management over a plurality of locations. In some embodiments, a plurality of systems such as system 101 is implemented at each location, and data is transmitted from each location to a back-office system. Then data such as:
Brand, location, and product performance across the plurality of locations
Levels of inventory across the plurality of locations, comprising, for example:
   States of kegs across the plurality of locations,
   Levels of bottles
Staff performance across the plurality of locations;
Top selling products across the plurality of locations;
Top-performing locations;
Worst selling products; and
Worst performing locations;
   is collected and analyzed so as to provide vital information and improve profitability. In some embodiments, the back-office system is comprised of a cluster of globally distributed remote servers, all interconnected to work together to increase performance, reliability, scalability, and accessibility.

Returning to FIG. 1, vendor subsystems 110 are subsystems owned by vendors such as food and beverage suppliers. Other components of system 101 send orders or requests to these vendor subsystems using interconnections 103.

Third-party subsystems 108 are subsystems provided by organizations other than vendors outside of the bar or the restaurant. Examples include:
Subsystems owned by, for example, payment processor organizations; and
Subsystems provided by Government regulatory bodies.

As explained above, two examples of a monitoring device 105 are a tabletop inventory monitoring device and a keg monitoring device. The tabletop inventory monitoring device is designed for mounting on a tabletop and is used to, for example, measure either the weight or remaining volume of substance within containers such as bottles and jars.

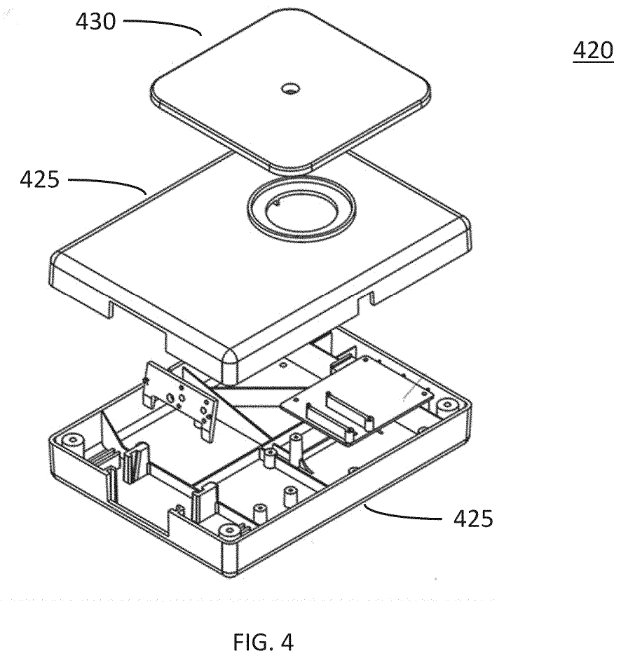

FIGS. 4-8 illustrate an exemplary embodiment of a tabletop inventory monitoring device 420. The tabletop inventory monitoring device 420 enables continuous monitoring of the consumption of substances such as liquor, wine, and beer which are stored in containers such as bottles and jars over a period of time.

In some embodiments, the tabletop inventory monitoring device 420 records measurement data related to the weight of a container holding a substance. This measurement data is used to determine the consumption of the substance within the container within a period of time. The determination of consumption is carried out, for example, by processing subsystems 230-1 to 230-N.

An example of measurement of consumption within a bartender shift using tabletop inventory monitoring device 420 is as follows: At the start of a shift, for every bottle of liquor, wine, and beer, user 109, such as a bartender, scans a unique identifier associated with the bottle using scanning camera 445. This identifier is, for example, a UPC, EAN, and QR code. The scanned identifier data is transmitted to database 232, where it is checked against stored container identifier data by, for example, processing subsystems 230-1 to 230-N to identify the substance within the bottle.

The bartender then places each bottle of liquor or wine onto the scale plate 430 to determine the starting weight of each substance. This initial measurement data is transmitted to processing subsystems 230-1 to 230-N using interconnections 103.

At the end of the shift, the bartender weighs the bottles of liquor and wine using tabletop inventory monitoring device 420. This final measurement data is transmitted to processing subsystems 230-1 to 230-N using interconnections 103. A detailed description of a method of management of liquor and wine substances will be described further below.

The processing subsystems 230-1 to 230-N perform one or more of the following operations using the initial and final transmitted measurement data:
Determination of consumption of the substance during the shift. In some embodiments, as part of this determination, the processing subsystems convert weight to volume to determine the volume of the substance consumed. This is done using, for example, density data corresponding to the substance and stored in database 232. The determined consumption is stored in, for example, database 232.
Determination of revenue generated during the shift based on the above determination of the consumption of the substance and, for example, price data stored in database 232. The generated revenue is stored in, for example, database 232.
Determination of the occurrence of a fraud event based on a comparison of the determined revenue generated with billing data received from billing subsystem 106, or comparison of the revenue generated with consumption data received from the consumption analysis subsystem 107.
Determination of the cost of the consumption of the substance during the shift based on the above determination of the consumption of the substance and, for example, cost data stored in database 232.
Determination of the remaining stock of the substance based on the above determination of the consumption. In some embodiments, this is carried out in conjunction with inventory management subsystem 102.
Determination of the time to exhaustion of the remaining stock based on the above determination of the remaining stock and past consumption data stored in database 232. In some embodiments, this is carried out in conjunction with inventory management subsystem 102;
Trend analysis;
Staff management and enterprise management.

The data from one or more of the above operations is stored in database 232.

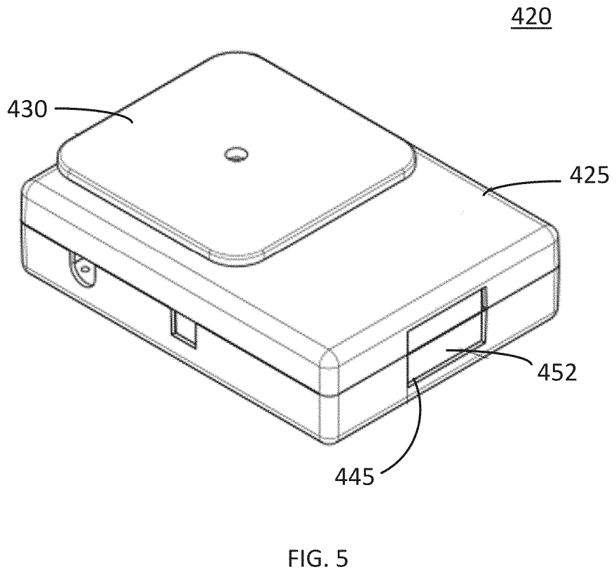

Similarly, the tabletop inventory monitoring device 420 can monitor the consumption of bottled beer. Referring to FIG. 5, as bottles of beer are purchased by the consumer, the bartender scans an identifier such as a UPC code of each bottle with the scanning camera 445. The tabletop inventory monitoring device 420 recognizes the identifier belonging to a specific bottle of beer and stores the number of bottles scanned. At the end of the shift, the data collected by the tabletop inventory monitoring device 420 is sent to processing subsystems 230-1 to 230-N where the information on the number of bottles scanned or sold is computed by processing subsystems 230-1 to 230-N. Processing subsystems 230-1 to 230-N can then perform one or more of the determinations detailed above.

Referring again to FIG. 4, in other embodiments, the tabletop inventory monitoring device 420 is incorporated within a bar rail, on liquor display shelves, or in wine storage areas. Tabletop inventory monitoring device 420, together with processing subsystems 230-1 to 230-N assist in providing accurate and real-time monitoring of the consumption of the liquors. This is accomplished through the use of individual weigh scales for individual liquor bottles or through a single large scale measuring the weight of multiple bottles at once. As consumption occurs, the loss of weight is assigned to a specific bottle either through the use of a bottle-specific scale, or through a system of identifying what bottle was removed from a large single scale. The system can include but is not limited to UPC or other identifier scanning cameras, motion sensors, levers that account for removal and insertion bottles. A worker skilled in the relevant art can appreciate the various elements that can be used to track the movement of bottles, which can also include the use of specific trackers attached to the individual bottles. The enablement of a real-time or live bar rail monitoring system helps maintain the integrity of the bar rail for managers, as it assists in effectively monitoring and controlling the revenue that is generated from the consumption of the fastest-selling liquor in a bar or restaurant.

With reference to FIG. 5, a perspective view of the tabletop inventory monitoring device is shown for an example embodiment where the identifier is a UPC code. The weigh scale plate 430 is shown on top of the device, with the scanning camera 445 located within the UPC reader port 452.

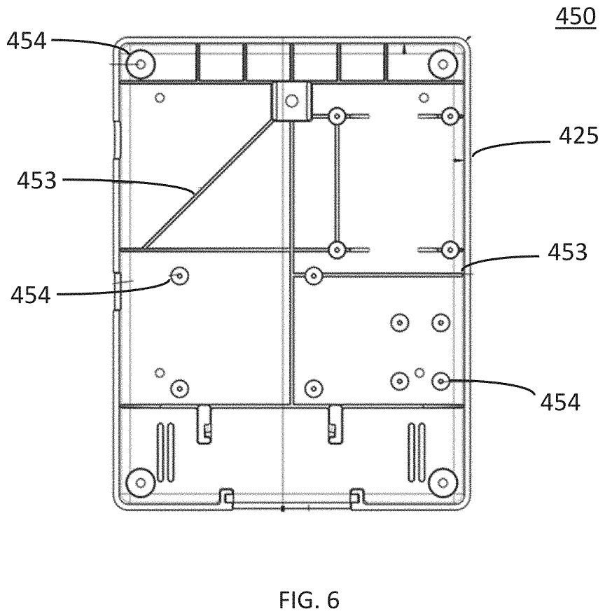

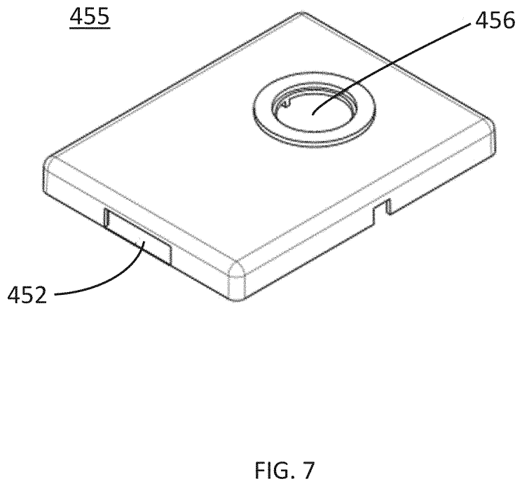

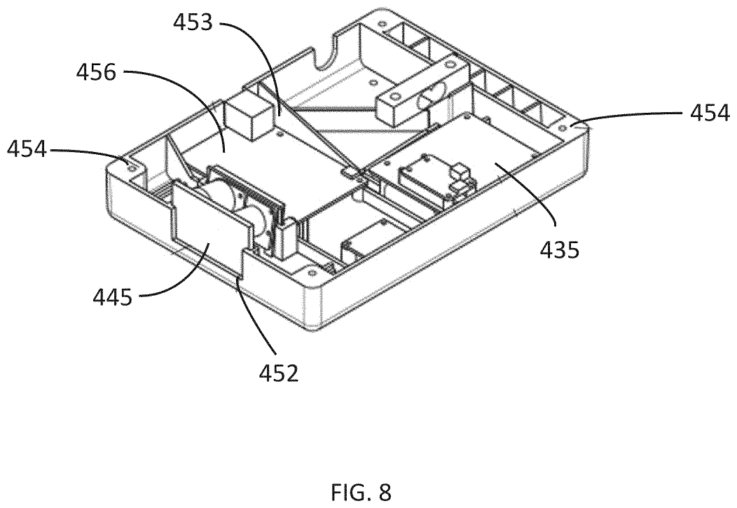

The scale housing 425 is comprised of a scale housing base 450, as further illustrated in FIG. 6 and FIG. 8, and the scale housing lid 455 as further illustrated in FIG. 7. A worker skilled in the relevant art would appreciate that the scale housing 425 can be comprised of various elements and can be either unique to the tabletop inventory monitoring device or a generic element. A worker skilled in the relevant art would also appreciate that the role of the scale housing 425 entails housing the unique elements while providing a region or a port where the scanning camera 445 can read identifiers such as UPC codes and an aperture for the weigh scale (not shown) can interact with the bottles housing the liquor or wine.

With reference to FIG. 6, the scale housing base 450 is shown. The scale housing contains a UPC reader port (not shown) and numerous channels 453 and columns 454. The UPC reader port (not shown) provides a location for the placement of the scanning camera (not shown) that is on the outer surface of the scale housing 425, which allows the camera to read the UPC codes of the liquor or wine bottles. Additional apertures are located throughout the scale housing base, which provide additional ports for connection to a power source or connection point to other tabletop inventory monitoring devices or external scanners (not shown). The numerous channels 453 provide for specific locations for the placement of various internal elements of the tabletop inventory monitoring device. These elements include but are not limited to: a battery, a processor; a wireless transmitting device for connection to interconnections 103 of FIG. 1 and thereby the other components of system 101; and a weighing mechanism, an analog to digital (A/D) converter; and a scanning camera. The A/D converter serves to convert analog data into digital data before transmission over interconnections 103, so as to enable transmission over an extended distance. The columns 454 interact with the elements of the scale housing lid 455 in order to provide connection points.

With reference to FIG. 7, the scale housing lid 455 is shown. The scale housing lid 455 contains a scale aperture 456, which provides an unobstructed connection with the weigh scale plate (not shown) and the weighing device (not shown). Additionally, a UPC reader port 452 can be seen, which connects to the UPC reader port of the scale housing base (not shown).

With reference to FIG. 8 and according to one embodiment, the tabletop inventory monitoring device 420 is shown without the scale housing lid and the weight scale. The scale housing lid and the weigh scale have been removed to depict the inner working of the tabletop inventory monitoring device 420. The tabletop inventory monitoring device 420 contains a scanning camera 445, a battery 435, and a weigh scale mechanism 456 housed within the scale housing. A worker skilled in the relevant art would appreciate the various elements that can be incorporated into the tabletop inventory monitoring device 420.

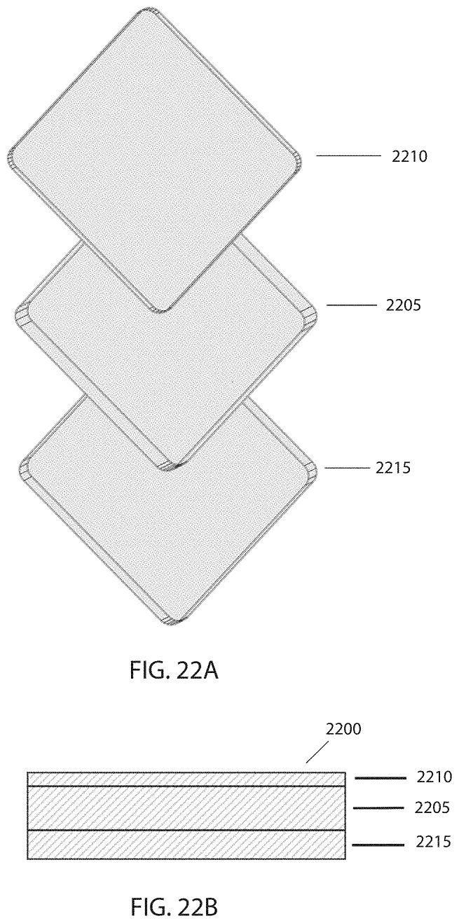

FIGS. 22-28 illustrate a further exemplary embodiment of a tabletop inventory monitoring device, which is a coaster 2200. The coaster 2200 enables continuous monitoring of the consumption and/or sale of substances such as liquor, wine, beer, food, minerals, chemicals, and drugs, which are stored in containers such as bottles and jars over a period of time.

With reference to FIGS. 22A and 22B, an exploded view (FIG. 22A) and side view (FIG. 22B) show an example embodiment of the coaster 2200. The coaster 2200 includes a circuit layer such as a printed circuit board 2205 sandwiched by a flat top layer 2210 and flat bottom layer 2215. The top and bottom layers 2210, 2215 may be made of poured plastic resin, thus providing a low-cost low profile product.

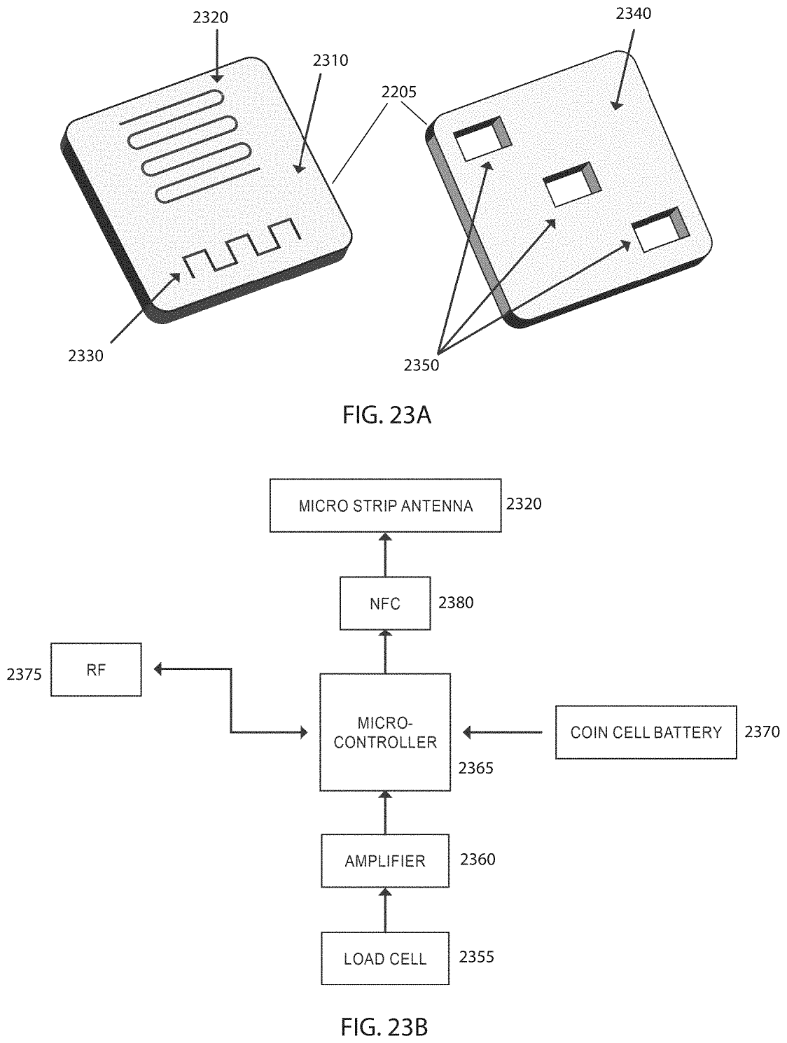

Referring to FIG. 23A, the top surface 2310 of the printed circuit board 2205 may have an inlaid near field communication (NFC) micro-strip antenna 2320. The NFC micro-strip antenna 2320 interfaces with an NFC tag sticker (not shown) that has been encoded with a serial number and adhered to a bottle/container bottom. When the bottle/container is placed on the coaster 2200, the NFC micro-strip antenna 2320 wirelessly transmits a small power to the NFC tag and reads its serial number to determine the identity of the bottle placed on it. Thus any bottle could be placed on any coaster to obtain a weight; the bottle does not need to go back on the same coaster.

A weight sample of the bottle/container and its contents is captured by a load cell (not shown) in the circuit board 2205 and sent out to a receiver. A radiofrequency (RF) antenna 2330 inlaid in the printed circuit board 2205 may be used for transmitting to the receiver (not shown) and communicating with a system 101 such as that illustrated in FIG. 1. The printed circuit board 2205 may have a bottom surface 2340 with cutout spaces 2350 for positioning components of the circuit board, including a coin cell battery.

Referring to FIG. 23B, a flow chart of the communications from the coaster 2200 is shown. A load cell 2355 for weighing containers and/or substances connects to and communicates with an amplifier 2360, which in turn communicates with a micro-controller 2365. The micro-controller 2365 is charged, for example, by a coin cell battery 2370 that may be a rechargeable battery or a solar rechargeable battery, and communicates with other system components 101 via radiofrequency 2375 to the receiver (not shown). The micro-controller 2365 also communicates by near field communication (NFC) 2380 via the microstrip antenna 2320.

In an alternate embodiment of the coaster 2200, the wires in the coaster may be directly routed to the circuit board 2205 rather than incorporating a load cell 2355. As the load on the coaster 2200 changes with a change in volume of a container and/or substance, the circuit board flexes and changes in resistance, thereby sensing the load. Thus the deflection of the circuit board 2205 may act as a load sensor.

The coaster 2200 may also have a light-emitting diode (LED) light that will turn on once the level of alcohol in the bottle is down to a preset level, set by the bar manager, letting a bartender know a new bottle is needed. The LED light also signals the main application, letting the manager know there are bottles at the bar that need to be replaced, allowing minimal change times. The LED is also visible so that if the bar manager is not at a computer and in the bar, he can quickly see the containers that need to be replaced.

The weights recorded on the coaster 2200 are live, which means the bartender is not required to do inventory, saving costs in wages. The coaster 2200 will time out and reset, so if there is no container detected on the coaster for a set period of time, for example, two minutes, the coaster shuts off and resets so it can be used with the next end-user. The coaster 2200 is also disposable, so when the battery 2370 dies, the manager may simply replace the coaster.

The coaster 2200 may connect to a beer/liquor application (app), so when an end-user receives their drink and coaster, their phone will prompt them to download the app. The app and coaster 2200 connect the user to the main system application 101, which will record the user's information, for example, what the user ordered, the time of the order, how many drinks were ordered, and how long the user stayed at the location. This information may be shared with the brand being consumed, where those brands will be able to communicate with the user directly, offering customer benefits to using their products. Contests, promotions, free gifts, first notice of new products, feedback from the customer to both the supplier and the bar are some examples of customer benefits that may be offered. The app could be used in any bar or restaurant, thereby improving the customer and supplier experience.

Each coaster 2200 may also have smooth surface touch locations on the coaster, each touch location serving a specific task. For example, there may be three touch locations, one for sending a server to a table, one to request another drink, and the third to request the bill. The coaster 2200 would be connected to the bar or restaurant point of service via the app, so if the end user had any concerns, the end-user could directly contact the manager to address the situation.

The coaster could also be used in promotional events for suppliers. Suppliers could put coasters in packaging, such as beer cases, and customers could link to the app and win prizes, take part in contests, and provide feedback to the suppliers.

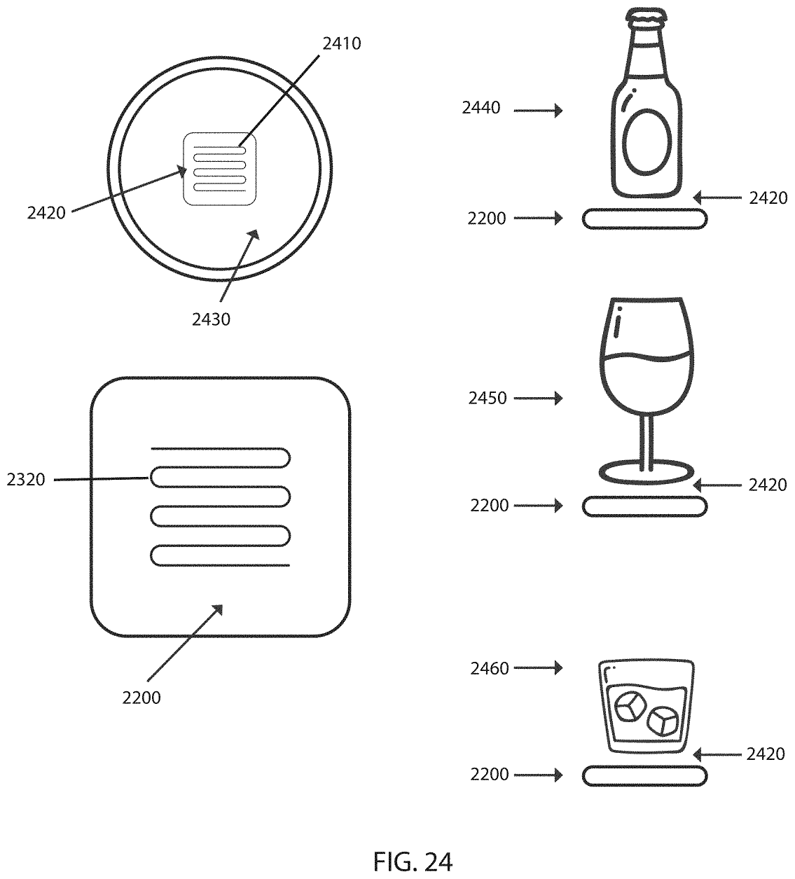

Referring to FIG. 24, the microstrip antenna 2320 on the coaster 2200 communicates with an NFC antenna 2410 located on a tag 2420 on the bottom of a substance container 2430. The substance container may be a drink container, such as a beer bottle 2440, wine glass 2450, or tumbler 2460. Thus the coaster 2200 is able to communicate with the drink container 2430 to identify the substance in the container and monitor the weight of the container and the substance while it is being consumed through the load cell 2355. The information on the weight and the container identity is relayed by the micro-controller 2365 by radiofrequency to the system 101.

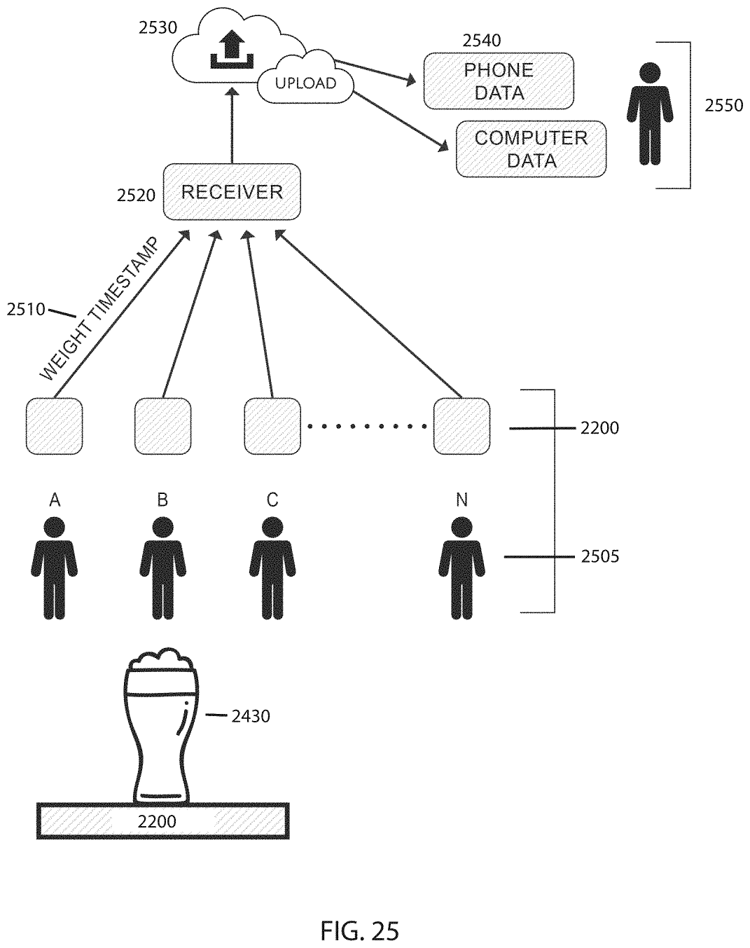

With reference to FIG. 25, an example of measurement of consumption using the coaster 2200 is as follows: end-users 2505-A to 2505-N are each provided drinks such as beer or wine in a container 2430. The containers 2430 are placed on respective coasters 2200-A to 2200-N. As the users 2505 consume their drinks, the coaster 2200 provides information on the type of drink by communication from the antenna 2410 on the drink container tag 2420 to the antenna 2320 on the coaster 2200 and live updates of the weight of the container 2430 and drink by the load cell 2355 measurement. The information on the container identity and weight is time-stamped 2510 and is relayed to a receiver 2520 by for example, radiofrequency. The information may then be further relayed to a remote computer server 2530. The remote server 2530 may then relay the information to a user-interface 2540, for example, as phone data or computer data, to a business user 2550.

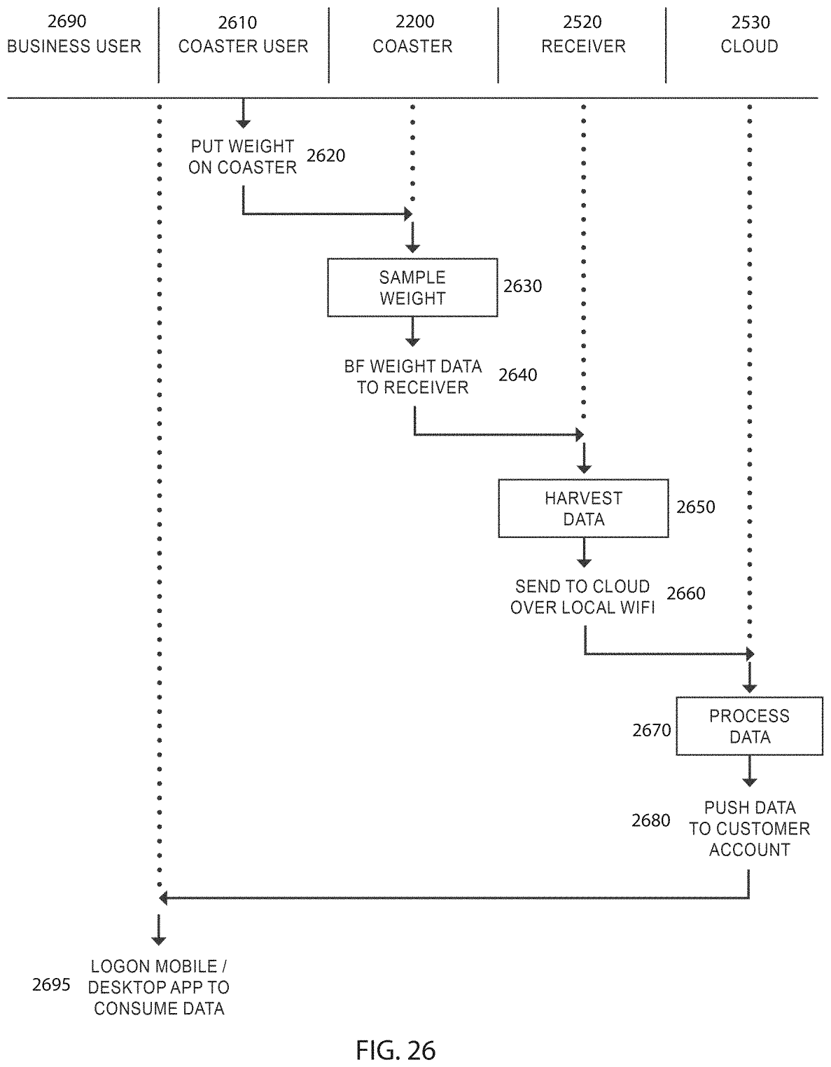

With reference to FIG. 26, a method for using the coaster 2200 to monitor substance consumption is further illustrated. A coaster end-user 2610 puts weight 2620 on the coaster 2200 in the form of a container holding a substance. The coaster 2200 takes a sample weight 2630 and sends the weight data 2640 to the receiver 2520. The receiver 2520 processes the weight data 2650 and sends the data 2660 to a remote server 2530 through a local wireless communication system. The remote server 2530 further processes the data 2670 and pushes the processed data 2680 to the business user 2690, through, for example, the business user's customer account. The business user, 2690 can then consume the data on a mobile or desktop computer application 2695.

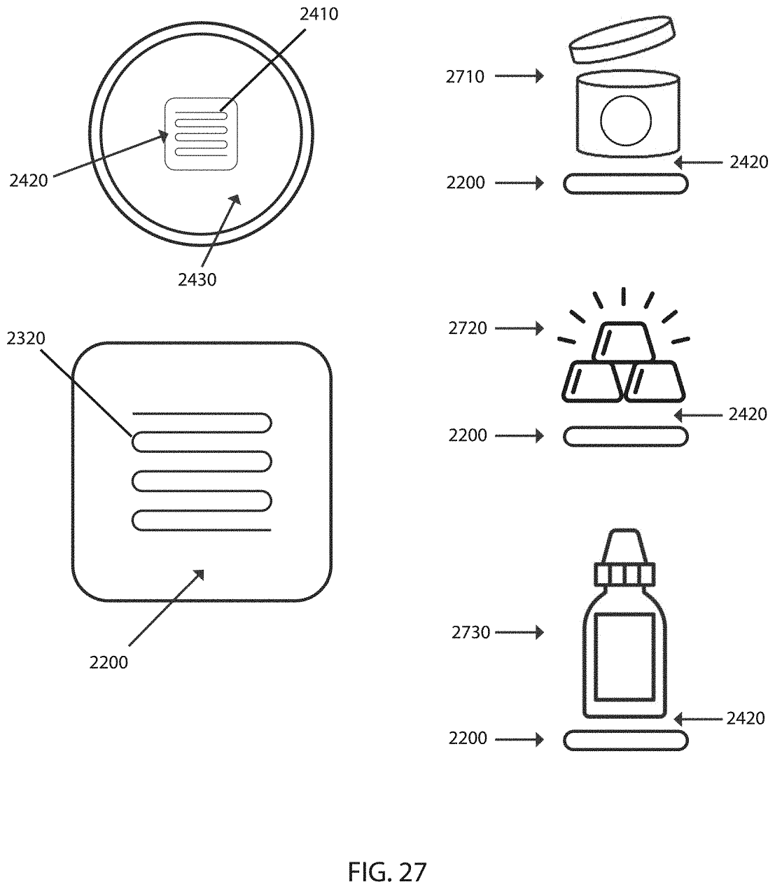

With reference to FIG. 27, the coaster 2200 may be used to monitor the weight of substances such as, but not limited to, drinks, food, marijuana 2710 or pharmaceutical substances, precious metals 2720, and chemicals 2730. The substances to be monitored have a tag 2420 on the substance container 2430 or on the substance itself bearing an NFC antenna 2410 that communicates with the complementary NFC antenna 2320 on the coaster 2200. In this way, the coaster 2200 identifies the substance and measures and provides a time-stamped weight of the substance.

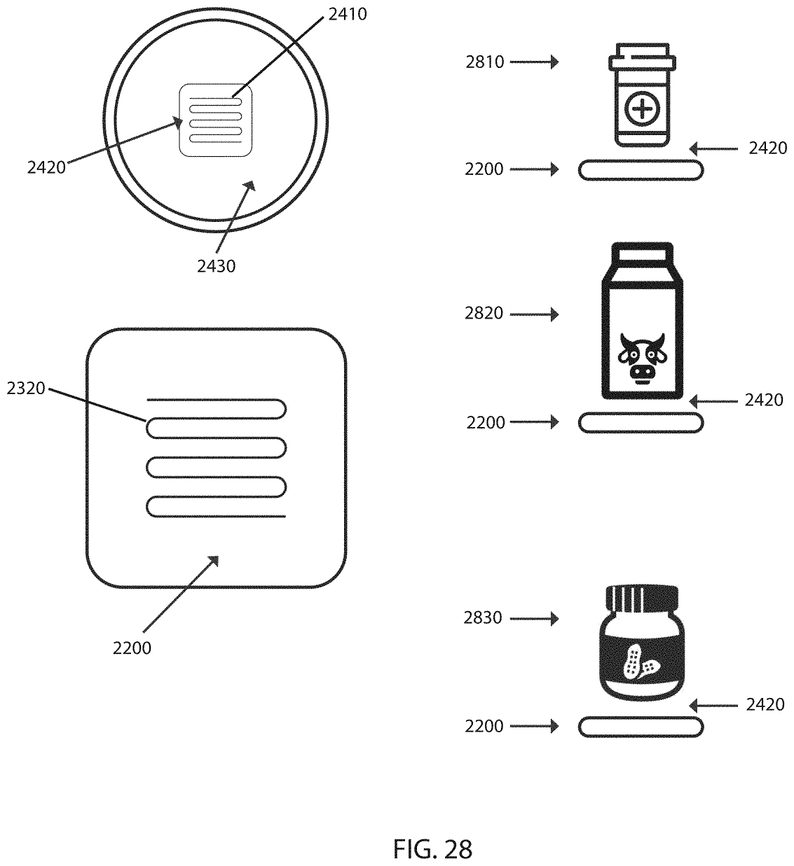

With reference to FIG. 28, other applications of the coaster device are in measuring pharmaceutical products 2810, drink products 2820, and food products 2830.

In some embodiments, the coaster 2200 records measurement data related to the weight of a container holding a substance. This measurement data may be used to determine the consumption of the substance within the container within a period of time. The determination of consumption is carried out, for example, by processing subsystems 230-1 to 230-N.

The processing subsystems 230-1 to 230-N perform one or more of the following operations using the transmitted measurement data from the coaster:
Determination of consumption of the substance during the shift. In some embodiments, as part of this determination, the processing subsystems convert weight to volume to determine volume of the substance consumed. This is done using, for example, density data corresponding to the substance and stored in database 232. The determined consumption is stored in, for example, database 232.
Determination of revenue generated during the shift based on the above determination of the consumption of the substance and, for example, price data stored in database 232. The generated revenue is stored in, for example, database 232.
Determination of the occurrence of a fraud event based on a comparison of the determined revenue generated with billing data received from billing subsystem 106, or comparison of the revenue generated with consumption data received from the consumption analysis subsystem 107.
Determination of the cost of the consumption of the substance during the shift based on the above determination of the consumption of the substance and, for example, cost data stored in database 232.
Determination of the remaining stock of the substance based on the above determination of the consumption. In some embodiments, this is carried out in conjunction with inventory management subsystem 102.
Determination of the time to exhaustion of the remaining stock based on the above determination of the remaining stock and past consumption data stored in database 232. In some embodiments, this is carried out in conjunction with inventory management subsystem 102;
Trend analysis;
Staff management and enterprise management.

The data from one or more of the above operations is stored in database 232.

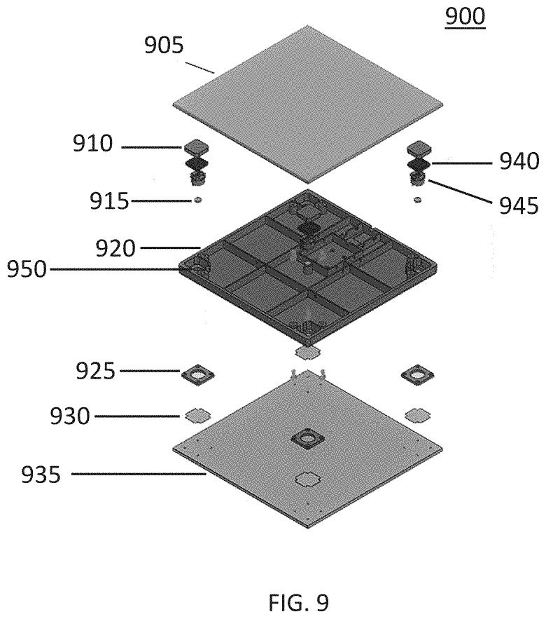

With reference to FIG. 9 and according to one embodiment, the keg inventory monitoring device 900 is shown. The keg inventory monitoring device 900 enables continuous monitoring of the consumption of substances stored in larger containers, such as kegs or barrels, over a period of time.

The keg inventory monitoring device 900 is comprised of: a top plate 905, separated from a bottom plate 935 by a keg scale housing 920. At each of the four corners of the keg inventory monitoring device 900, there are arranged the following components: a seal 910, a load sensor 940, a foot 945, a magnet 915, a locating ring 925, and an insert 930. When assembled, each different component should be substantially coplanar. In the four corners, the vertical arrangement of the component centers should also be substantially coplanar. Further, the vertical planes should be substantially orthogonal to the horizontal planes. In practice the coplanar nature of the planes and the orthogonal relationship to each other will not be perfect and any deviation will result in measurement error. The of the keg inventory monitoring device design minimizes this error.

The keg scale housing 920 attaches to the underside of the top plate 905, for example, with screws. Inside the keg scale housing 920 is an area for electronics (not shown) that convert the analog differential signals from the load sensors 940 into a digital code. A path is provided to allow a cable to connect the electronics to a remote device for data collection. In each of the four corners of the keg scale housing 920 is a pocket 950 in which a foot 945, a load sensor 940, and a seal 910 sit.

Each load sensor 940 attaches to the electronics. The arrangement of the load sensors 940 inside the keg scale housing 920 is constructed such that the center of the load points (not shown) of the load sensors 940 are arranged in a square. Each foot 945 is exactly on the center of this load point. A square arrangement is required because of the nature of performing a differential measurement of load sensors 940. A deviation from a square arrangement will result in measurement error. If the load is off-center and the load point arrangement is square, a simpler compensation factor can be applied than would otherwise be required with a non-square arrangement.

The top side of the top plate 905 is the platform on which the container (for example, a keg) being weighed sits. The keg scale housing 920 is attached to the underside of the top plate, for example, with screws. The top plate and thus the applied load ultimately rest on the four feet 945 at the corners of the top plate 905. Consequently, the top plate 905 material should be of sufficient rigidity so as not to deform or bow under the maximum applied load. Any significant deformation would result in measurement error.

The top side of the bottom plate 935 provides a flat rigid surface upon which the four feet rest. In order for the most accurate weight measurements to be made, the bottom of the feet 945 and thus the load sensors 940 must be substantially coplanar. The bottom plate 935 provides this coplanar surface allowing the entire keg inventory monitoring device to be placed on rough and/or uneven surfaces. The four locating rings 925 and inserts 930 are attached to the topside of the bottom plate 935 by, for example, screws. The bottom plate 935 requires rigidity so as to not deform easily and provide a consistent coplanar surface. However, since the underside of the bottom plate 935 is mostly resting on a surface, it could be less rigid and/or of a different material than the top plate 905.

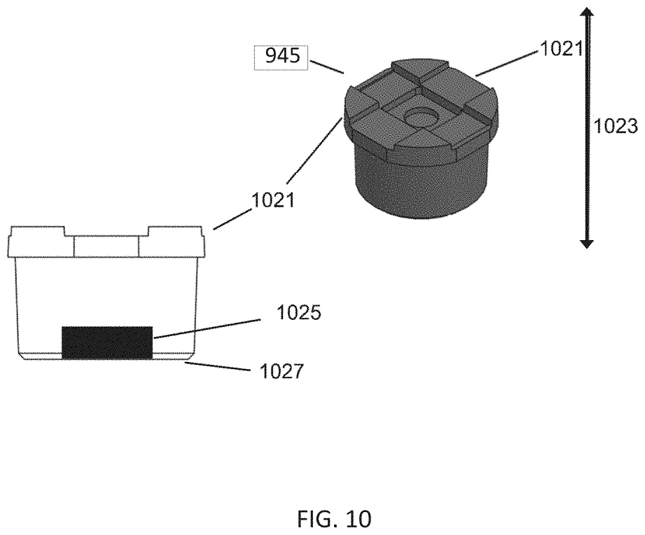

Referring to FIG. 10, the foot 945 provides the sensor in the keg inventory monitoring device 900. The topside 1021 of the foot 945, when mated with the load sensor 940 sits exactly in the center of the load point (not shown) of the load sensor. Placing a load on the keg inventory monitoring device 900 generates a downward force 1023 through the center of each foot 945. An equal but opposite force upwards 1023, which is referred to as a normal force, is also generated. The load sensor 940 (which is a strain gauge), is a transducer and converts the normal force 1023 to an analog electrical signal, which in combination with the other three load sensors 940 can be measured and the applied weight or force deduced. If the bottom of the feet 1027 do not rest on a coplanar surface, then the normal force 1023 in each foot will be different, resulting in measurement error. In the bottom of the foot 1027 is a magnet pocket 1025 for a magnet 915, which magnetically couples with the locating ring insert 930. If a load is placed exactly in the center of the scale, each foot 945 will sense exactly one-quarter of the applied force. Any deviation from a square arrangement of the feet 945, and thus the load points of the load sensors 940, will result in more force being applied to one or more of the feet 945 and less to others. This will result in measurement errors.

The four locating rings 925 and inserts 930 are attached to the topside of the bottom plate 935 by for example, screws. The foot 945 sits inside the circular aperture of the locating ring 925. The magnet 915 in the bottom of the foot 1027 magnetically couples to the insert 930. The insert 930 sits between the locating ring 925 and the top side of the bottom plate 935. The insert 930 should be ferromagnetic since the material used for the bottom plate is not. The combination of the magnetic attraction coupling the feet 945 to the insert 930 and the height of the circular aperture of the locating ring 925 lock the top and bottom parts of the assembly together. During events such as keg changes or a scale being bumped, locking the top and bottom parts of the assembly together ensures that they cannot slide apart easily, thus maintaining the keg inventory monitoring device 900 integrity.

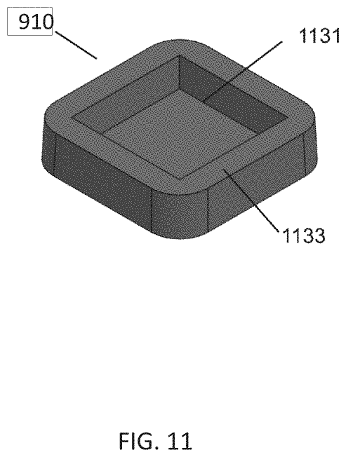

In order for the normal force 1023 to be sensed, the foot 945 and load sensor 940 need to press against something. This cannot be the underside of the top plate 905 because the center part of the load sensor 940, called the bridge, flexes upwards with applied force. There would be nowhere for it to flex if it sat flat against the plate. The seal 910 sits between the load sensor 940 and the underside of the top plate 905. Referring to FIG. 11, the pocket 1131 of the seal 910 provides a space into which the load sensor 940 bridge can flex. The outer edge 1133 of the seal 910 fixes the outer edge of the load sensor 940 in place.

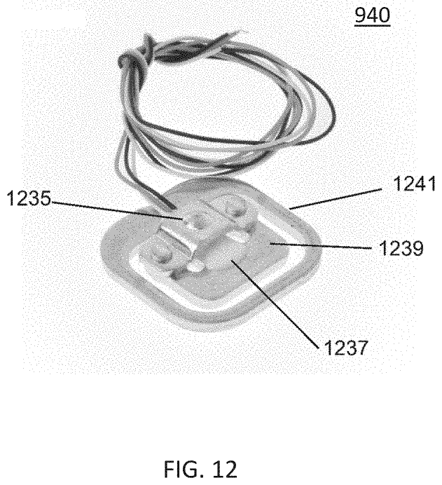

Referring to FIG. 12, an embodiment of a load sensor 940 is shown. When a force is applied to the load point 1235 of the load sensor 940, the resistors embedded in the epoxy 1237 deform, changing their resistance away from the nominal unloaded value. The outer edge 1241 of the load sensor 940 is fixed in place. The bridge 1239 of the load sensor 940 flexes downwards in response to an applied force. Four load sensors 940 are connected together in an electrical configuration referred to as a Wheatstone bridge to minimize errors due to differences in the individual load sensors. When connected in this manner, load sensors 940 are called a load cell. If an excitation voltage is applied to the load cell and the return signal is measured, the difference is proportional to the applied force.

A weighing scale must normally be calibrated before use in order to determine certain constants that will be used with an equation to convert the digital code output by the scale into an actual weight. For various reasons, a scale with no weight on it will never report exactly zero (i.e., no weight). However, the difference from zero is used to calculate the weight on the scale. During calibration, the digital code output by the scale with no weight is recorded. This is called the zero point. It represents the weight of the scale parts above the sensors and the inherent offset of the sensors. Subsequent calculations subtract the zero point from the current digital code to arrive at a value that represents only the weight actually on the scale. However, over time the zero point of a scale may drift. This could be due to a number of factors, including repositioning the scale; scale is not level; change in temperature affecting physical scale parts, sensors, and electronics; noise due to electromagnetic interference affecting sensors and electronics; noise inherent in the electronic measuring circuit; wear of physical scale parts; break-in or wear of the sensors; and hysteresis effect of the sensors.

All of these effects add up cumulatively, and an increase in count by one error may be offset by a decrease in another. However, whether or not the error introduced matters depends on the desired accuracy, precision, and repeatability required of the weighing scale. In standard weighing scales, the operator, before using the scale to weigh an object, will tare the scale with no weight on it. This is called the tare count. It represents the difference between the zero point and the current digital code output by the scale. Subsequent calculations subtract this value as well from the digital code.

Normally an operator will tare a scale by pressing a button or tapping the scale platform in a specific manner. In the case of the Keg Scale, the location of the scale, the weight of the objects being put on the scale, and the general construction of the scale make operator taring impractical. Further, the accuracy, precision, and repeatability required of the scale is significant such that the error introduced by zero point drift cannot be ignored.

The weights being measured by the keg inventory monitoring device 900 are not continuous over a range of zero to a maximum value. The smallest weight that will be measured is equivalent to the weight of the smallest empty container that will be used with the keg inventory monitoring device 900. Knowing this weight, the keg inventory monitoring device 900 can assume that any digital code of equivalent weight less than that of the empty container means there is no weight on the scale. The keg inventory monitoring device 900 monitors for this condition, and when present, it records the digital code as the tare value. This is done multiple times a second. When a weight of more than the smallest empty container is detected, the tare value is no longer updated, and the most recent value is used in subsequent calculations.

The keg inventory monitoring device 900 may operate as a continuously monitoring system. The measurement of a weight of the keg and the draught beer are continuously transmitted to processing subsystems 230-1 to 230-N using interconnections 103. This measurement data is used to determine the consumption of the substance within the keg within a period of time. The determination of consumption is carried out, for example, by processing subsystems 230-1 to 230-N.

The processing subsystems 230-1 to 230-N perform one or more of the following operations using the transmitted measurement data:
Determination of consumption of the substance during the shift. In some embodiments, as part of this determination, the processing subsystems convert weight to volume to determine the volume of the substance consumed. This is done using, for example, density or specific gravity data corresponding to the substance and stored in database 232. The determined consumption is stored in, for example, database 232.
Determination of revenue generated during the shift based on the above determination of the consumption of the substance and, for example, price data stored in database 232. The generated revenue is stored in, for example, database 232.
Determination of the occurrence of a fraud event based on a comparison of the determined revenue generated with billing data received from billing subsystem 106.
Determination of the cost of the consumption of the substance during the shift based on the above determination of the consumption of the substance and, for example, cost data stored in database 232.
Determination of the remaining stock of the substance based on the above determination of the consumption. In some embodiments, this is carried out in conjunction with inventory management subsystem 102.
Determination of the time to exhaustion of the remaining stock based on the above determination of the remaining stock and past consumption data stored in database 232. In some embodiments, this is carried out in conjunction with inventory management subsystem 102.

The data from one or more of the above operations is stored in database 232.

The user, can be apprised of the change in the amount of draught beer remaining in the keg as the weight of the keg is displayed in real-time, for instance, on display 104-3 of the user device 104 via app 104-4. As beer is poured, the weight of the keg is gradually decreased, which is measured by the keg inventory monitoring device 900 and displayed to the bartender. The ability to assess the amount of draught beer poured is similar to that of conventional flow rate meters, except the keg inventory monitoring device is not plagued with misreading due to increased keg temperatures and foaming.

The keg inventory monitoring device 900 and the consumption analysis subsystem 107 may determine the amount of draught beer within the keg based on previous data collected and stored in the database 232. For example, the make and style of beer may be input using app 104-4 and input devices 104-5 by a user 109, and stored in the database 232. The processing subsystems 230-1 to 230-N, with the data from the database 232 on the make and style of beer, will determine the weight of the keg and the weight of the draught beer within. The determined weight of draught beer is used to calculate the amount of revenue that can be generated. Furthermore, based on the variation of the weight in the draught beer, processing subsystems 230-1 to 230-N can determine whether a new keg was tapped. This provides for an effective and efficient way to monitor the stock.

The consumption analysis subsystem 107 may further provide an accurate live monitor of the consumption of beer by differentiating a true pour event, when beer is purposely dispensed, from a false pour event. Events such as keg transfer, tapping a new keg, or a vibration such as a fridge door closing may produce spurious false pour events, because the keg inventory monitor device 900 continuously monitors weight changes of the keg and beer. Processing subsystem 230-1 to 230-N, using information stored in the database 232 may differentiate a true pour event from a false pour event through, for example, performing Fourier analysis of the transmitted time-domain weight data to determine the presence of high frequency content which is an indicator of a false pour event. For example, the system detects a false pour event if the keg weight apparently decreases and returns very quickly, or if the recorded weight decreases quickly and then substantially increases. The consumption analysis subsystem 107 is also able to adjust volume calculations by:
Determining an amount of foam produced when beer is poured, based on temperature data and distance data related to a distance from a container such as a keg to a tap, and
Determining a volume of spillage based on the determination of foam produced.
   A detailed description of a method of management of kegs will be described further below.

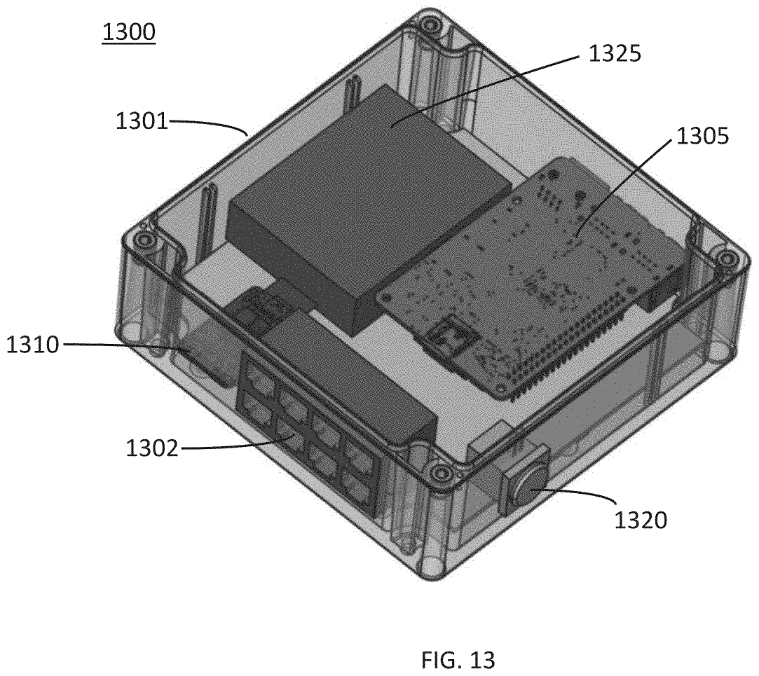

As explained previously, in some embodiments, monitoring devices 105 are coupled to interconnections 103 via an intermediary device. An example is now detailed, where keg inventory monitoring device 900 is connected to an intermediary device in the form of control unit 1300 shown in FIG. 13. The control unit 1300 serves various functions with regard to keg inventory monitoring device 900. As will be explained further below, control unit 1300:
Supplies keg inventory monitoring device 900 with power;
Receives analog data from keg inventory monitoring device 900;
Converts analog data received from keg inventory monitoring device 900 to digital data using an analog-to-digital (A/D) converter before transmission over interconnections 103, so as to enable transmission over an extended distance; and
Transmits converted digital data received from keg inventory monitoring device 900 to consumption analysis subsystem 107 where it is, for example, stored in database 232 or further processed by processing subsystems 230-1 to 230-N.

The control unit 1300 in FIG. 13 is primarily comprised of: box unit 1301; keg scale connection jacks 1302; a computer processor 1305; an analog to digital converter 1310; a power management circuit 1320; and a power supply 1325. The box unit 1301 is a customized box that encloses the control unit 1300 and protects the system from external elements. The control unit 1300 may accommodate 8 or up to at least 32 keg scales, which will each plug into a keg scale connection jack 1302. The computer processor 1305 may provide a function to identify the specific keg inventory monitoring device that is plugged into a given keg scale connection jack 1302, through a digital identification associated with the specific keg inventory monitoring device 900.

The keg scale connection jacks 1302 serve a dual function. Firstly, the weight data of the keg placed on the keg inventory monitoring device 900 is transferred to the control unit 1300 through the wired connection to the scale connection jack 1302. Secondly, the control unit 1300 provides power to the keg inventory monitoring device 900, which will subsequently allow the scale to measure the weight of the kegs. A worker skilled in the relevant art would appreciate the various mechanisms that could be used to replace the corded system requiring the keg scale connection jacks 1302. For example, the information can be transmitted wirelessly from the keg inventory monitoring device 900 to the control unit 1300, and the keg inventory monitoring device could be powered by a battery unit. The analog to digital converter 1310 converts the analog data obtained from weight measurement of the keg to a digital format prior to transmission over interconnections 103. In another embodiment, the analog to digital converter 1310 can be positioned on the keg inventory monitoring device 900 and the digital data is transferred directly to the control unit 1300. A worker skilled in the relevant art would appreciate the various known mechanisms to convert analog data into digital. The battery charge boost 1325 and the power management circuit 1320 provide power to the control unit 1300. The battery charge boost 1325 allows the control unit 1300 to run when the control unit 1300 is not directly connected to a power source, or in times of a power outage. The power management circuit 1320 allows the user to rest the control unit 1300 by disconnecting the power for the duration of pressing the power management circuit.

The control unit 1300, upon receiving the data from the keg inventory monitoring device 900 may transfer the data via interconnections 103 to consumption analysis subsystem 107 where it is stored in database 232.

Tracking the consumption of substances may be achieved through an application such as app 104-4 running on user device 104. App 104-4 is coupled to the other components of system 101 in FIG. 1 via user device 104 and interconnections 103. User 109 is able to view the output of app 104-4 through, for example, display 104-3; and interacts with app 104-4 via input devices 104-5 of user device 104. App 104-4 allows the user to complete functions such as taking inventory using user device 104; and also for user 109 to enter data into database 232 of consumption analysis subsystem 107. User 109 inputs data into database 232 such as the cost per unit consumed the amount of stock, the source of new stock, the time required to obtain new stock, and other elements which are central to subsequent analysis of the consumption of substances.

In one embodiment, when user 109, such as a bartender, wishes to log into app 104-4, the user 109 authenticates themselves or signs in using a username and password. A worker skilled in the relevant art would appreciate the various means of the bartender authenticating themselves or signing into the account, including but not limited to: face recognition; and a unique nametag with a unique QR code. Once the user 109 has successfully logged into the app 104-4, they are able to view data such as the inventory data of the bar or restaurant. In some embodiments, the inventory data is either viewed on the cloud or downloaded to user device 104 every time a user starts an inventory count. In the embodiments where inventory data is downloaded to user device 104, inventory data is only maintained on user device 104 during an active session. Once the active session is over, the user submits the completed inventory data to database 232. The need to update upon logging into app 104-4 is to ensure new inventory from another user is accounted for. Upon completion of the inventory, and scanning and weighing active and open liquor and wine bottles, an identifier such as the UPC code is scanned, and identified by processing subsystems 230-1 to 230-N using data stored in database 232. The user/bartender will then place the identified container onto the integrated scale on the tabletop monitoring device. The tabletop monitoring device then transmits the weight of the container, including the contents inside the container, to processing subsystems 230-1 to 230-N. Processing subsystems 230-1 to 230-N then calculates the weight of the contents inside the container using a special algorithm that uses the identification of the container to derive the weight of the container and therefore can determine the weight of the contents of the container, eliminating the weight of the container, also known as the tare weight. The data that is used in the algorithm is stored in database 232. In some embodiments, tare weights cannot be stored in the system, as bottle sizes and weights can change from time to time. Therefore, the algorithm is used to determine the tare weight of the container at the time of weighing. A worker skilled in the relevant art would appreciate that the algorithm can operate in conjunction with the data stored in the cloud to provide accurate and reliable weight readings for the substances contained within the bottles.

App 104-4 allows user 109 to interact with the other components of system 101 from user device 104 as necessary. User 109 will log into app 104-4 via supplying a password and username. This authentication data is transmitted to database 232, where it is correlated against existing records and used to identify the role played by user 109 and unlocks capabilities based on the authorization levels of user 109. App 104-4 is used by user 109 to view and display the state of all of the kegs placed on the keg inventory monitoring device. When a keg that is filled with a certain draught beer comes within a configurable threshold amount, an alert will be sent to app 104-4 by, for example, processing subsystems 230-1 to 230-N, indicating the keg will need attention, and based on trending sales, will indicate the time it will need to be changed. This data can be sent to multiple user devices 104 operating app 104-4. All kegs that are placed on their own respective keg inventory monitoring device will show on app 104-4 how much contents remain, will indicate if the respective draught beer of the keg is currently being poured, and certain alerts can be configured, for example, to alert if a keg tap is left open.

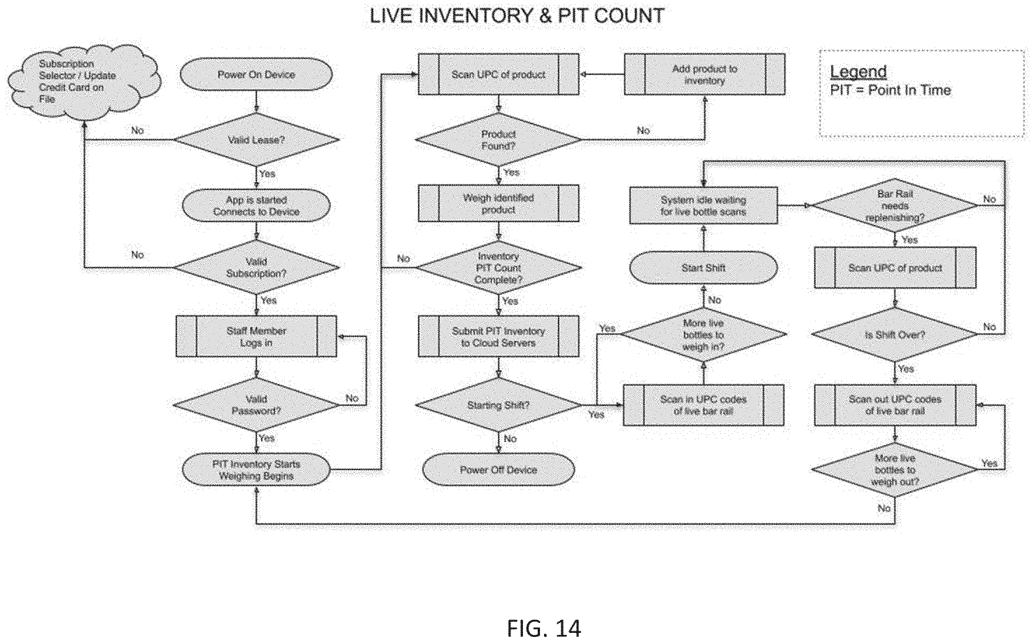

With reference to FIG. 14, a method of management of liquor and wine substances is shown. In step 1401, the tabletop inventory monitoring device 420 is powered on, and couples to processing subsystems 230-1 to 230-N via interconnections 103. In step 1403, tabletop inventory monitoring device 420 prompts processing subsystems 230-1 to 230-N to perform a check to determine whether there is a valid lease. In step 1405, app 104-4 is started up on user device 104, and the user device 104 connects via interconnections 103 to tabletop inventory monitoring device 420. In step 1409, tabletop inventory monitoring device 420 prompts processing subsystems 230-1 to 230-N to perform a check to determine whether there is a valid subscription. If any one of the checks in step 1403 or in step 1409 fail, then in step 1407, either a new subscription is selected, or a credit card is updated by processing subsystems 230-1 to 230-N.

In step 1411, the user 109 logs into app 104-4 using, for example, a user name and a password or one of the other previously described means of signing into the account. Processing subsystems 230-1 to 230-N determine if the entered authentication information is valid. An example is shown in FIG. 14, where in step 1413, a password check is performed by processing subsystems 230-1 to 230-N. If the password check fails, then the user 109 is prompted to re-enter the password. If the password check succeeds, then the user 109 progresses to the start of the current point-in-time (PIT) inventory process and weighing bottles in step 1415.

As previously described, user 109, such as a bartender, scans a unique identifier associated with the bottle using scanning camera 445. An example is shown in step 1417, where the bartender scans a UPC. The identifier data is transmitted to consumption analysis subsystem 107, and a check to determine if the substance corresponding to the identifier can be found in database 232. An example is shown in step 1419, where a check is performed using the information stored in database 232 to determine if a UPC can be found. If not, then in step 1423 the user adds products to the inventory in database 232 using app 104-4. App 104-4 also allows a user 109 to include price/cost of inventory and the sale price of the product in database 232.

If in step 1419, the product is found in database 232, then in step 1421 the bartender then weighs the bottle to determine the starting weight of each substance. This initial measurement data is transmitted to processing subsystems 230-1 to 230-N using interconnections 103. The weight of the specific liquor is stored in the database 232. Processing subsystems 230-1 to 230-N then use one or more algorithms to determine the weight and volume of the substance using the one or more calculation data stored in database 232, such as bottle weight and specific gravity. The determined weight and/or volume is transmitted to user device 104 and provided to app 104-4. This is performed until the entire PIT inventory is complete. In some embodiments, the bar or restaurant may set up zones of locations such as: front bar; back bar; beer fridge; and overstock. The substances available to the different zones will vary and will include but are not limited to: open spirits; open wine; active beer bottles; and unopened overstock products. The active liquor and wine in all zones are weighed.

By step 1427, the PIT inventory data is transmitted to processing subsystems 230-1 to 230-N and also, for example, inventory management subsystem 102 in FIG. 1. In step 1429, the user indicates using, for example, app 104-4 whether it is the start of a shift. If yes, then in steps 1433 and 1435 the process of scanning identifiers and weighing is performed for the bar rail, similar to steps 1417 and 1421.

After the shift starts (step 1437), the system 101 waits for “live” scans and weighing in step 1439. If in step 1441 it is determined that the bar rail needs replenishing, then the unique identifier of the depleted product is scanned in step 1443. If in step 1441, no replenishing is needed then the system 101 returns to step 1439 where it waits.

If the shift is determined to be over in step 1445, then in steps 1447 and 1449 the user scans and weighs the bottles in the live bar rail, similar to the steps performed in steps 1433 and 1435. In step 1449, measurement data relating to the measured weights are transmitted to processing subsystems 230-1 to 230-N. Then processing subsystems 230-1 to 230-N retrieve one or more of the previously described calculation data from database 232 to calculate:
volume of each of the substances consumed,
generated revenue related to consumption of each of the substances,
cost related to consumption of each of the substances, and
remaining stock of each of the substances.

After all the bottles in the live bar rail have been weighed, a user returns to step 1415 and repeats steps 1417-1429. Since it is not the start of the shift, the user then powers off tabletop inventory monitoring device 420 in step 1431.

In some embodiments, at the end of the shift, a status report is provided to app 104-4 by processing subsystems 230-1 to 230-N, which includes but is not limited to: bartender counts; total revenue; total missing/over pour/spillage; shopping list; order fulfillment; budget; pour cost; and projections. App 104-4 can be directed to perform automatic ordering of the liquor, wine, spirits, and wine. The order is made, and a report is sent to the manager for approval.

A large selection of available products is continuously updated on database 232, and the user can select the inventory from the list. The selection includes major brands, their identifiers such as UPC codes, full bottle weight, and density or specific gravity.

In some embodiments, app 104-4 couples to monitoring devices 105 directly over interconnections 103. App 104-4 couples to each monitoring device to receive measurement data from the monitoring device. For example, app 104-4 couples to a keg inventory monitoring device using a full-duplex communications channel, thereby enabling continuous and always available feed from each keg in the customer's establishment. The keg inventory monitoring device holds the keg on the scale for a live inventory reading.

In some embodiments, app 104-4 connects to monitoring devices 105 via the previously described intermediary unit, such as control unit 1300 of FIG. 13. More than 32 kegs can be connected to a control unit, where the logic and state of the keg is processed and calculated.

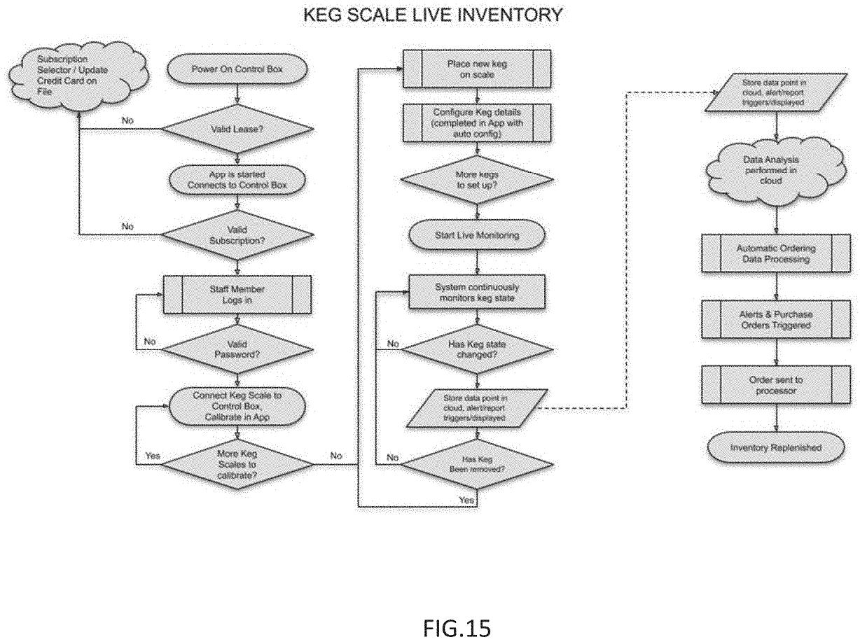

With reference to FIG. 15, the method of management of draught beer in kegs is illustrated. In step 1501, control unit 1300 is powered on, and couples to processing subsystems 230-1 to 230-N via interconnections 103. In step 1503, control unit 1300 prompts processing subsystems 230-1 to 230-N to perform a check to determine whether there is a valid lease. In step 1505, app 104-4 is started up on user device 104, and the user device 104 connects via interconnections 103 to control unit 1300. In step 1509, control unit 1300 prompts processing subsystems 230-1 to 230-N to perform a check to determine whether there is a valid subscription. If any one of the checks in step 1503 or in step 1509 fail, then in step 1507, either a new subscription is selected or a credit card is updated by processing subsystems 230-1 to 230-N.

In step 1511, the user 109 logs into app 104-4 using, for example a user name and a password or one of the other previously described means of signing into the account. Processing subsystems 230-1 to 230-N determine if the entered authentication information is valid. An example is shown in FIG. 15, where in step 1513, a password check is performed by processing subsystems 230-1 to 230-N. If the password check fails, then the user 109 is prompted to re-enter the password. If the password check succeeds, then the user 109 progresses to connecting a keg inventory monitoring device 900 to control unit 1300, and using the calibration data stored in database 232, the keg inventory monitoring device 900 is calibrated.

When all the keg inventory monitoring devices have been calibrated (step 1517) a new keg is placed on each keg inventory monitoring device 900 in step 1519. The initial measurement data is transmitted to consumption analysis subsystem 107 for storage in database 232. Upon placement of the new keg on the keg inventory monitoring device, processing subsystems 230-1 to 230-N will confirm the new keg to the user 109 via app 104-4. Processing subsystems 230-1 to 230-N, based on the data contained within the database 232, determine the brand of the draught beer in the keg, whether the same is available in stock, and will recommend the same draught beer to replace upon empty.

In step 1521 the keg details are configured using app 104-4.

Once all the kegs have been set up on the keg inventory monitoring devices in step 1523, live monitoring begins in step 1525.

In step 1527, during normal operation of the keg scale, processing subsystems 230-1 to 230-N will continuously poll keg inventory monitoring devices 105 for the current weight of the keg, also known as the state of the keg. As the draught beer is being consumed, the keg inventory monitoring device will monitor the loss of weight. As the bartender pours a draught beer, the keg inventory monitoring device transmits the weight at the start and at the end of the pour as part of the measurement data transmitted to the processing subsystem 230-1 to 230-N. The measurement data or current state data is also transmitted to, for example, app 104-4 or other components of system 101 as needed. In some embodiments, processing subsystem 230-1 to 230-N provides the brand of draught being poured. At the end of every pour, the bartender is provided with an end weight of the keg. The app 104-4 also provides the amount of draught beer poured into glass/pitchers and the pour sizes corresponding to the difference in start and end weight of the keg. A visual representation of the pouring is also displayed on app 104-4.

In step 1529, if the state of the keg is determined by processing subsystem 230-1 to 230-N to have changed, then the new state data is stored in database 232 in step 1531. If the keg is removed (step 1533), then steps 1519 to 1531 are repeated.

Step 1531 further comprises sub-steps 1537 to 1545, which are now discussed in more detail.

In step 1537, if there is a change in the state of the keg, then a data analysis is performed by, for example, processing subsystems 230-1 to 230-N. This includes:
Receiving the measurement data from the keg inventory monitoring device 900;
Retrieving one or more of the previously described calculation data from database 232 to calculate:
   volume of each of the substances consumed,
   generated revenue related to consumption of each of the substances,
   cost related to consumption of each of the substances, and
   remaining stock of each of the substances.

The data analysis further includes, for example,
differentiating a true pour event from a false pour event as previously described;
adjusting volume calculations taking into account an amount of foam produced when beer is poured;
adjusting for the temperature of the beer using a temperature sensor;
determining the current fill level of the keg, that is, what percentage of the capacity of the keg remains;

In steps 1539 and 1541, data processing for automatic re-ordering and triggering of purchase orders is performed. In some embodiments, user 109 sets weight threshold limits using app 104-4. When these thresholds are reached, processing subsystems 230-1 to 230-N are prompted to begin data processing for automatic re-ordering of draught beers. In some embodiments, the thresholds and prior use data are used by processing subsystems 230-1 to 230-N to determine when a bar or restaurant lacks the number of kegs to manage the predicted consumption rates. Processing subsystems 230-1 to 230-N will then begin data processing to create an order for the draught beer that has been deemed to be insufficient to handle the predicted use. In some embodiments, the threshold is continually varied, based on patterns of previous use, and is determined by, for example, predictive analytics or AI/ML techniques. When the stock of draught beer is nearing the threshold, which is 25% capacity, or a percentage set by the bar/restaurant, the data processing to create an order begins.

In step 1541, based on the data processing of step 1539, purchase orders are triggered. In some embodiments, app 104-4 is used to perform steps 1539 and 1541, that is, create and trigger a purchase order for reorder of the draught beer based on usage, predicted future usage, and based on delivery time. In yet other embodiments, step 1541 includes a requirement for the bar/restaurant to accept the order prior to it being submitted. In some embodiments, the data processing for automatic re-ordering and triggering of purchase orders in steps 1539 and 1541 is performed by processing subsystems 230-1 to 230-N together with ordering subsystem

Step 1541 may also include alerting steps. When a keg is determined to be close to being emptied, alerts are sent to, for example, app 104-4 or other systems to replace the keg. For example, when a keg is at 25% of capacity, an alert is sent. In some embodiments, one or more subsequent alerts are configured to be sent as the keg approaches 0% capacity. For example, after sending an initial alert when the keg is at 25%, subsequent alerts are sent when the keg is at 10% and 5% capacity, thereby further providing alerts to the bar/restaurant prior to running out of the draught beer. If the keg is not replaced within a user selected time, an alert is sent to the app 104-4 to indicate replacement is required. Once the keg is replaced, the time and date is recorded on the processing subsystems 230-1 to 230-N.

In step 1543, the order is submitted. In some embodiments, this is performed via processing subsystems 230-1 to 230-N sending an order to vendor subsystems 110. Upon receipt of the ordered items, inventory is replenished in step 1545.

As with liquor and wine, in some embodiments, inventory is loaded into database 232 by the user 109 interacting with app 104-4. In other embodiments, information is retrieved from vendor subsystems 110 and inputted into database 232. In this way, a large selection of available products are continuously updated, and the user makes appropriate choices using app 104-4. The selection includes major brands, their identifiers such as their UPC codes, full keg weight, and specific gravity. App 104-4 enables a user to input the data into database 232 from the app 104-4 in case the substance is not found in database 232. App 104-4 also allows a manager/owner to include price/cost of inventory and the sale price of product on database 232.

The alerts described in step 1541 are not restricted to alerts for empty kegs. Other examples of alerts are provided below:
Temperature alerts: In some embodiments, the user monitors the temperature of the keg using app 104-4 either directly or indirectly via processing subsystems 230-1 to 230-N. If the temperature is outside of the normal range, an alert is sent to app 104-4 by, for example, processing subsystems 230-1 to 230-N to advise the bartender of the issue.
Over and under-pour alerts: In some embodiments, processing subsystems 230-1 to 230-N transmit alerts to app 104-4 to a user such as a bartender of over or under poured. If the processing subsystem 230-1 to 230-N, based on data received from the keg inventory monitoring device, determines that the pour has not to have stopped, an alarm is triggered. The alarm is generally based on the amount of draught beer poured in a single pour. The amount is determined by the processing subsystem 230-1 to 230-N, and is configured to be more than 3 pitchers in weight. The alarm is configured to increase in intensity if the loss of continuous weight continues.
Alert of object placed on keg: In some embodiments, when processing subsystem 230-1 to 230-N determines that weight is increasing based on data received from the keg inventory monitoring device, it sends an alarm to app 104-4. This increase in weight is an indication that an object has been placed on the keg.
Removal of keg: As the processing subsystems 230-1 to 230-N are continuously monitoring the weight of the keg, the removal of a keg and the placement of a new keg will alert processing subsystems 230-1 to 230-N as to a dramatic change in weight, and will alert the bartender in the app 104-4 as to the change of kegs.

In general draught beer will generally be consistently placed on the same line. However, if a different draught beer is placed on the keg inventory monitoring device, the keg lines would be required to be cleaned. If that is the case, the bartender will be provided with time to inform processing subsystems 230-1 to 230-N via app 104-4 that a new draught beer is being placed into the keg inventory monitoring device.

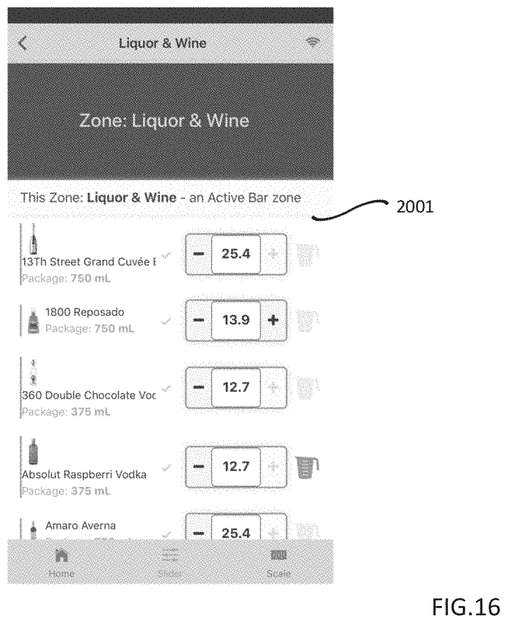

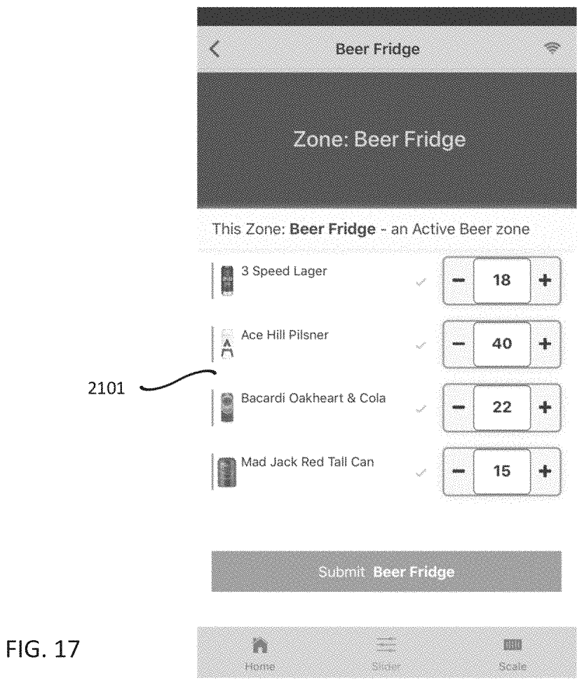

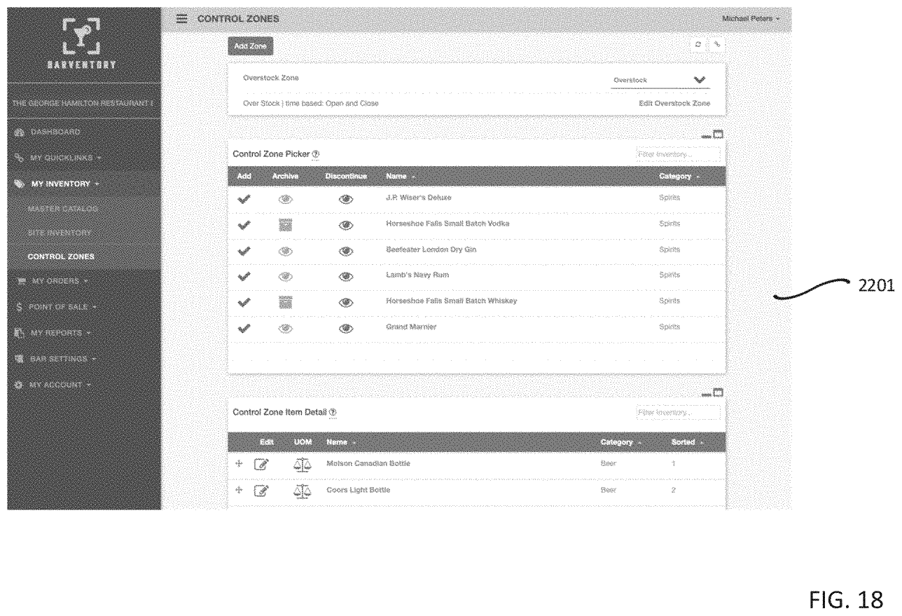

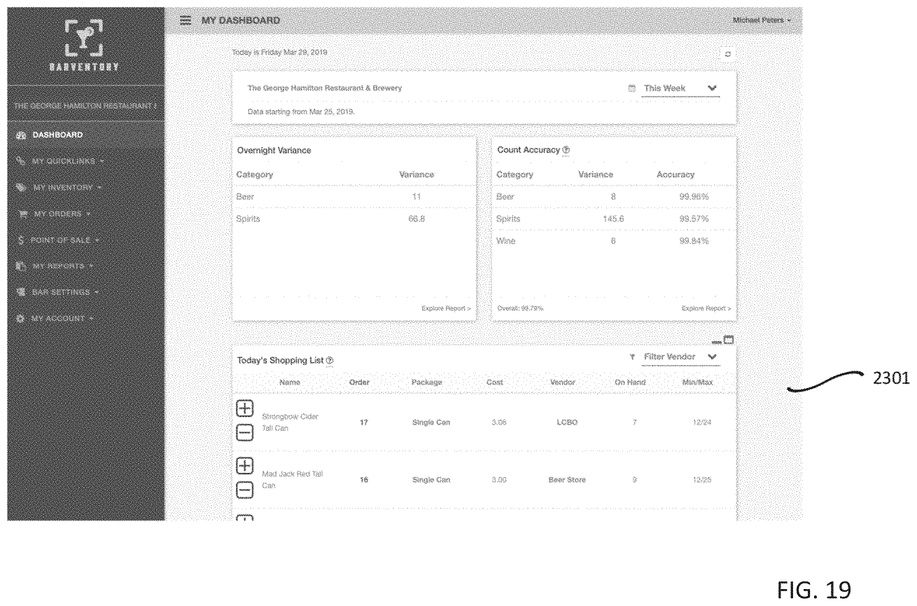

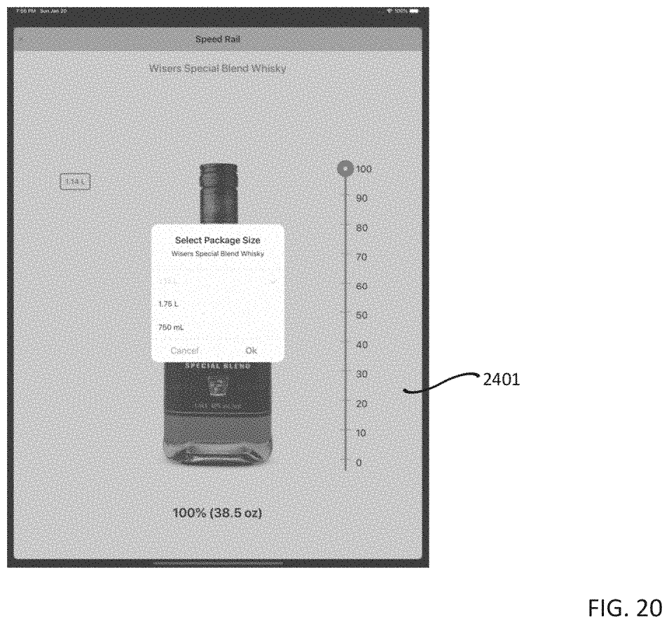

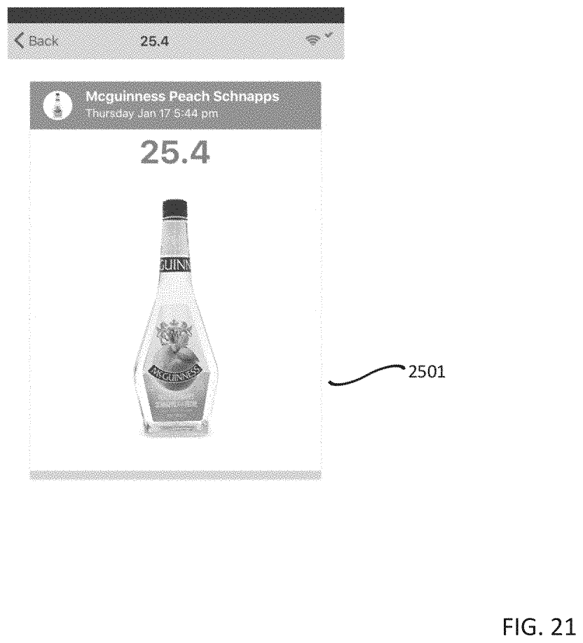

In some embodiments, app 104-4 comprises one or more interfaces to enable the user to interact with one or more components of system 101. Example interfaces are presented below:
Interface 2001 in FIG. 16 enables the user to enter a substance inventory;
Interface 2101 in FIG. 17 enables the user to enter an inventory number of stock;
Interface 2201 in FIG. 18 depicts an inventory control list to enable the user to make selections;
Interface 2301 in FIG. 19 depicts an example of a dashboard for a user such as a bartender to close a shift; and
Examples of visual representations 2401 and 2501 of pourings displayed on app 104-4 are shown in FIGS. 20 and 21.

While embodiments of the substance monitoring system and method have been illustrated in the accompanying drawings and described herein, it will be appreciated by those skilled in the art that various modifications, alternate constructions, and equivalents may be employed.

In one embodiment, the invention provides a method for live monitoring sales of a substance, comprising: storing one or more calculation data related to a plurality of substances on a database; scanning one of the plurality of substances to identify the substance; transmitting a measurement data related to a measured weight of the substance to a processing subsystem; retrieving at least one portion of the one or more calculation data from the database by the processing subsystem; determining, based on at least one portion of the measurement data and the retrieved at least one portion of the one or more calculation data, at least one of: a volume of the one of said plurality of substances; a generated revenue related to the one of the plurality of substances; a cost of consumption related to the one of the plurality of substances; and a remaining stock of the one of the plurality of substances.

The embodiment of the invention in which an exclusive property or privilege is claimed is defined as follows:

1. A system for real-time monitoring of a consumption of a plurality of substances comprising:
a monitoring device, wherein the monitoring device measures a weight of one of the plurality of substances;
a consumption analysis subsystem coupled to the monitoring device via one or more interconnections,
wherein the consumption analysis subsystem comprises a database and a processing subsystem coupled to each other via one or more analysis subsystem interconnections, further wherein:
the database stores one or more calculation data related to the plurality of substances, wherein:
the one or more calculation data comprises at least one of:
one or more density or specific gravity data;
one or more revenue data;
one or more cost data; and
one or more inventory data;
the monitoring device transmits a measurement data related to the weight via the one or more interconnections to the consumption analysis subsystem; and
the processing subsystem:
receives the transmitted measurement data via the one or more analysis subsystem interconnections;
retrieves at least one portion of the one or more calculation data from the database via the one or more analysis subsystem interconnections; and
determines, based on at least one portion of the measurement data and the at least one portion of the one or more calculation data, at least one of:
a volume of the one of the plurality of substances;
a generated revenue related to the one of the plurality of substances;
a cost of consumption related to the one of the plurality of substances; and
a remaining stock of the one of the plurality of substances.

2. The system of claim 1, wherein the plurality of substances comprises at least one of a plurality of beverages, food, drugs, metals, chemicals or pharmaceutical products held in containers.

3. The system of claim 1, wherein the weight of one of the plurality of substances comprises the weight of a container holding a volume of one of the plurality of substances.

4. The system of claim 1, wherein the monitoring device comprises a tabletop monitoring device and the tabletop monitoring device further comprises a scanner for optically scanning and identifying the one of the plurality of substances.

5. The system of claim 3, wherein the monitoring device comprises a keg monitoring device.

6. The system of claim 3, wherein the processing subsystem determines a volume of spillage.

7. The system of claim 6, wherein the calculation data further comprises:
one or more temperature data; and
one or more distance data related to a distance from the container to a tap; and
the processing subsystem determines a volume of foam based on the calculation data; and
the determination of the volume of spillage is based on the determination of the volume of foam.

8. The system of claim 5, wherein the calculation data further comprises:
one or more temperature data; and
one or more distance data related to the distance from the container to a tap; and
the processing subsystem determines a volume of foam based on the calculation data.

9. The system of claim 1, wherein measurement data produced by the monitoring device is initially in an analog format, and the measurement data is converted from an analog format to a digital format by an analog to digital converter before transmission to the processing subsystem.

10. The system of claim 9, wherein the conversion from the analog format to the digital format enables transmission over an extended distance.

11. The system of claim 2, wherein the processing subsystem analyzes received measurement data to determine when at least one of a pour event and replacement of the container occurs.

12. The system of claim 1, further wherein:
the processing subsystem is coupled to an inventory management system via the one or more interconnections; and
the processing subsystem and the inventory management system perform the determination of the remaining stock of the one of the plurality of substances.

13. The system of claim 1, further wherein the processing subsystem is coupled to a vendor subsystem via the one or more interconnections and the processing subsystem transmits a request to the vendor subsystem to place an order for the one of the plurality of substances based on the determination of the remaining stock.

14. The system of claim 1, further wherein:
a vendor subsystem is coupled to the consumption analysis subsystem via one or more interconnections; and
the processing subsystem retrieves an information about one of the plurality of substances from the vendor subsystems via the one or more interconnections for storage in the database.

15. The system of claim 1, further wherein the processing subsystem determines a time to exhaustion based on the determination of the remaining stock.

16. The system of claim 1, wherein:
the processing subsystem is coupled to a billing subsystem via the one or more interconnections;
the processing subsystem receives billing data from the billing subsystem via the one or more interconnections;
the processing subsystem compares the received billing data to determined generated revenue; and
the processing subsystem determines occurrence of a fraud event based on the comparison.

17. A system to enable real-time monitoring of a consumption of a plurality of beverages comprising:
one or more monitoring devices, wherein:
the one or more monitoring devices comprise at least one keg monitoring device or at least one tabletop monitoring device; and
the one or more monitoring devices measure one or more weights corresponding to one or more containers holding one or more volumes of one or more of said plurality of beverages;
a database and a processing subsystem coupled to each other via one or more interconnections, wherein:
the database stores one or more calculation data related to the plurality of beverages, wherein the one or more calculation data comprises at least one of:
one or more density data;
one or more revenue data;
one or more cost data; and
one or more inventory data;
a first of the one or more monitoring devices transmits a measurement data related to a first of the one or more weights to the processing subsystem via the one or more interconnections; and
the processing subsystem:
receives the transmitted measurement data;
retrieves at least one portion of the one or more calculation data from the database via the one or more interconnections; and
calculates, based on at least one portion of the measurement data and the at least one portion of the one or more calculation data, at least one of:
a first of the one or more volumes of the one of said plurality of beverages;
a generated revenue related to the one of the plurality of beverages;
a cost of consumption related to the one of the plurality of beverages; and
a remaining stock of the one of the plurality of beverages.

18. The system of claim 17, wherein:
each of the one or more monitoring devices has an identifier;
and further within:
the database stores the identifier and a corresponding calibration data for each of the one or more monitoring devices;
a first of the one or more monitoring devices transmits a first corresponding identifier to the processing subsystem;
the processing subsystem retrieves a first of the one or more stored calibration data from the database based on the received first corresponding identifier; and
the processing subsystem transmits the retrieved first calibration data to the first monitoring device.

19. The system of claim 17, further comprising at least one of:
a coupling between the processing subsystem and an inventory management system via the one or more interconnections; and the processing subsystem and the inventory management system perform a determination of the remaining stock of the one of the plurality of beverages;
a coupling between processing subsystem and an ordering subsystem via the one or more interconnections; and the processing subsystem transmits a request to an ordering system to place an order for the one of the plurality of beverages based on a determination of the remaining stock;
a coupling between the processing subsystem and a vendor subsystem via the one or more interconnections; and the processing subsystem transmits a request to the vendor subsystem to place an order for the one of the plurality of beverages based on a determination of the remaining stock;
a coupling between the processing subsystem is and a billing subsystem via the one or more interconnections; the processing subsystem receives billing data from the billing subsystem via the one or more interconnections; the processing subsystem compares the received billing data to the determined generated revenue; and the processing subsystem determines the occurrence of a fraud event based on the comparison.

20. The system of claim 1, wherein the monitoring device comprises a tabletop monitoring device and the tabletop monitoring device further comprises a receiver for receiving a radio signal from a transmitter on one of the plurality of substances.
